(19) United States
(12) Patent Application Publication
(10) Pub. No.: US 2025/0271707 A1
(43) Pub. Date: Aug. 28, 2025

(54) Light Modulation Module and Driving Method Thereof, Display Apparatus, and Light-Emitting Apparatus

(71) Applicants: BEIJING BOE DISPLAY TECHNOLOGY CO., LTD., Beijing (CN); BOE TECHNOLOGY GROUP CO., LTD., Chaoyang District, Beijing (CN); BEIJING BOE TECHNOLOGY DEVELOPMENT CO., LTD., Beijing (CN)

(72) Inventors: Yue Liang, Beijing (CN); Xibin Shao, Beijing (CN); Hongming Zhan, Beijing (CN); Feifei Wang, Beijing (CN); Jiantao Liu, Beijing (CN)

(21) Appl. No.: 19/116,413

(22) PCT Filed: Feb. 28, 2024
(86) PCT No.: PCT/CN2024/079074

§ 371 Date: Mar. 28, 2025

(51) Int. Cl. G02F 1/1343; G02F 1/133; G02F 1/1333; G02F 1/1335; G02F 1/13357

(52) U.S. Cl. CPC G02F 1/1343; G02F 1/13306; G02F 1/133371; G02F 1/133512; G02F 1/133603

(57) ABSTRACT

A light modulation module includes at least one light modulation unit. A light modulation unit includes a first substrate, a second substrate, a liquid crystal layer, a common electrode layer and a control electrode sub-module. The liquid crystal layer includes first liquid crystal molecules. The control electrode sub-module includes at least two control electrode layers and a dielectric layer; each control electrode layer includes a plurality of control electrodes. Orthographic projections of control electrodes included in two control electrode layers of the at least two control electrode layers on the second substrate are staggered in the first direction; for orthographic projections of the control electrodes included in at least two control electrode layers on the second substrate, adjacent orthographic projections are connected.

### CROSS-REFERENCE TO RELATED APPLICATION

This application is the United States national phase of International Patent Application No. PCT/CN2024/079074, filed Feb. 28, 2024, the disclosure of which is hereby incorporated by reference in its entirety.

### BACKGROUND OF THE INVENTION

### Field of the Invention

The present disclosure relates to the field of display technologies, and in particular, to a light modulation module and driving method thereof, a display apparatus, and a light-emitting apparatus.

### Description of Related Art

When a user uses a relatively private display device such as a mobile phone, a handheld tablet computer, or a notebook computer in public, the user usually does not want others to peek at the content displayed on the display apparatus. If the viewing angle of the display apparatus is large, people around the user will be able to clearly see the content displayed on the display apparatus within a certain distance, resulting in the leakage of the content involving the user's privacy due to being peeped by others, which is very detrimental to the confidentiality of personal information security.

### SUMMARY OF THE INVENTION

In an aspect, a light modulation module is provided. The light modulation module includes at least one light modulation unit. A light modulation unit includes: a first substrate and a second substrate that are assembled together, a liquid crystal layer, a common electrode layer and a control electrode sub-module. The liquid crystal layer is located between the first substrate and the second substrate, and the liquid crystal layer includes first liquid crystal molecules. The common electrode layer is located between the first substrate and the liquid crystal layer. The control electrode sub-module is located between the second substrate and the liquid crystal layer. The control electrode sub-module includes at least two control electrode layers and a dielectric layer located between two adjacent control electrode layers. Each control electrode layer includes a plurality of control electrodes arranged at intervals in a first direction. Orthographic projections of control electrodes included in two control electrode layers of the at least two control electrode layers on the second substrate are staggered in the first direction; for orthographic projections of control electrodes included in the at least two control electrode layers on the second substrate, adjacent orthographic projections are connected.

In some embodiments, the control electrodes of the at least two control electrode layers include a first electrode and a second electrode; orthographic projections of the first electrode and the second electrode on the second substrate are adjacently arranged. The orthographic projection of the first electrode on the second substrate and the orthographic projection of the second electrode on the second substrate have a first overlapping portion.

In some embodiments, a dimension of a control electrode of the control electrodes of the at least two control electrode layers in the first direction is a first width, and a dimension of the first overlapping portion in the first direction is a second width; a ratio of the second width to the first width is in a range of 2% to 10%, inclusive.

In some embodiments, a dimension of a control electrode of the control electrodes of the at least two control electrode layers in the first direction is a first width. Among a plurality of control electrodes of a control electrode layer of the at least two control electrode layers, two adjacent control electrodes have a first gap therebetween, and a dimension of the first gap in the first direction is a third width. A ratio of the first width to the third width is greater than or equal to 50% and less than or equal to 80%.

In some embodiments, the light modulation unit further includes a light-blocking layer. The light-blocking layer includes a plurality of light-blocking patterns arranged at intervals in the first direction; an orthographic projection of a light-blocking pattern on the second substrate substantially coincides with an orthographic projection of at least one control electrode of the control electrodes of the at least two control electrode layers on the second substrate.

In some embodiments, a surface of the first substrate proximate to the liquid crystal layer has a plurality of protrusions; the common electrode layer has a shape consistent with a shape of the plurality of protrusions. Alternatively, a surface of the second substrate proximate to the liquid crystal layer has a plurality of protrusions; the control electrode sub-module has a shape consistent with a shape of the plurality of protrusions.

In some embodiments, a surface of a protrusion of the plurality of protrusions proximate to the liquid crystal layer includes a plurality of sub-surfaces, a sub-surface is directly opposite to one or more control electrodes of the control electrodes of the at least two control electrode layers. The plurality of the sub-surfaces are arranged in a first shape, and the first shape includes one of a linear shape, a triangular shape and a parabola shape or a combination of more of a linear shape, a triangular shape and a parabola shape.

In some embodiments, the plurality of protrusions include a plurality of rectangular protrusions, and two adjacent rectangular protrusions have a gap therebetween.

In some embodiments, the light modulation unit further includes a first alignment film and a second alignment film. The first alignment film is located between the common electrode layer and the liquid crystal layer. The second alignment film is located between the control electrode sub-module and the liquid crystal layer. A surface of the first substrate proximate to the liquid crystal layer has a plurality of protrusions, the first alignment film has a shape consistent with a shape of the plurality of protrusions; a surface of the second substrate proximate to the liquid crystal layer has a plurality of protrusions, the second alignment film has a shape consistent with a shape of the plurality of protrusions.

In some embodiments, among the first substrate and the second substrate of the light modulation unit, one closer to a light exit side is a light exit substrate. The light modulation unit further includes a linear polarizer disposed on a surface of the light exit substrate away from the liquid crystal layer.

In some embodiments, a thickness of the dielectric layer is less than or equal to 2500 Å.

In some embodiments, a difference between an extraordinary refractive index of the first liquid crystal molecules and an ordinary refractive index of the first liquid crystal molecules is greater than or equal to 0.2.

In some embodiments, there exist a plurality of light modulation units, and the plurality of light modulation units are stacked in a thickness direction of the liquid crystal layer. Arrangement directions of control electrodes of two adjacent light modulation units are parallel or intersect with each other.

In some embodiments, there exist two light modulation units, the two light modulation units are stacked in a thickness direction of the liquid crystal layer, and arrangement directions of control electrodes of the two light modulation units are particular to each other.

In another aspect, a driving method of alight modulation module is provided. The light modulation module as described in any of the above embodiments. The driving method of the light modulation module includes: inputting control voltages to a plurality of control electrodes, and inputting a common voltage to the common electrode layer to drive the first liquid crystal molecules to rotate from an initial state to a first stable state, so that refractive index distribution of the light modulation unit is periodically arranged in the first direction entirely or locally.

In some embodiments, in a case where the first liquid crystal molecules rotate to the first stable state, the light modulation unit is divided into a plurality of first modulation portions arranged in the first direction; the plurality of first modulation portions have a same refractive index distribution; a first modulation portion includes at least two control electrodes; and a section of the first modulation portion corresponding to a control electrode has a first refractive index.

In some embodiments, in a case where the first liquid crystal molecules rotate to the first stable state, a plurality of first refractive indices of the first modulation portion gradually decrease and then gradually increase in the first direction, and change in a broken line shape; alternatively, in the case where the first liquid crystal molecules rotate to the first stable state, the plurality of first refractive indices of the first modulation portion gradually increase and then gradually decrease in the first direction, and change in a broken line shape.

In some embodiments, in a case where the first liquid crystal molecules rotate to the first stable state, a plurality of first refractive indices of the first modulation portion gradually decrease and then gradually increase in the first direction, and change in a parabolic shape; alternatively, in the case where the first liquid crystal molecules rotate to the first stable state, the plurality of first refractive indices of the first modulation portion gradually increase and then gradually decrease in the first direction, and change in a parabolic shape.

In some embodiments, in the case where the plurality of first refractive indices of the first modulation portion gradually decrease and then gradually increase in the first direction, a control electrode corresponding to a smallest one of the plurality of first refractive indices is located at a center of the first modulation portion. In the case where the plurality of first refractive indexes of the first modulation portion gradually increase and then gradually decrease in the first direction, a control electrode corresponding to a greatest one of the plurality of first refractive indexes is located at the center of the first modulation portion.

In some embodiments, in the case where the plurality of first refractive indices of the first modulation portion gradually decrease and then gradually increase in the first direction, a center of a control electrode corresponding to a smallest one of the plurality of first refractive indices deviates from a center of the first modulation portion. In the case where the plurality of first refractive indexes of the first modulation portion gradually increase and then gradually decrease in the first direction, a center of a control electrode corresponding to a greatest one of the plurality of first refractive indexes deviates from a center of the first modulation portion.

In some embodiments, in the case where the first liquid crystal molecules rotate to the first stable state, a plurality of first refractive indexes of the first modulation portion gradually decrease and decrease linearly in a second direction; alternatively, in the case where the first liquid crystal molecules rotate to the first stable state, the plurality of first refractive indexes of the first modulation portion gradually increase and increase linearly in the second direction. The second direction is a direction from a first border of the light modulation unit to a second border; the first border and the second border are arranged in the first direction.

In some embodiments, in a case where the first liquid crystal molecules rotate to the first stable state, the light modulation unit is divided into a plurality of second modulation portions and a plurality of third modulation portions arranged in the first direction. The plurality of second modulation portions have a same refractive index distribution; a second modulation portion includes at least two control electrodes; a section of the second modulation portion corresponding to a control electrode has a second refractive index; a plurality of second refractive indices of the second modulation portion decrease linearly in a second direction. The plurality of third modulation portions have a same refractive index distribution; a third modulation portion includes at least two control electrodes; a section of the third modulation portion corresponding to a control electrode has a third refractive index; a plurality of third refractive indices of the third modulation portion increase linearly in the second direction. The second direction is a direction from a first border of the light modulation unit to a second border; the first border and the second border are arranged in the first direction. The plurality of second modulation portions are located at a side, proximate to the first border, of the light modulation unit in the first direction, and the plurality of third modulation portions are located on a side, proximate to the second border, of the light modulation unit in the first direction; alternatively, the plurality of second modulation portions and the plurality of third modulation portions are alternately arranged in the first direction.

In some embodiments, a selected modulation portion is any one of the first modulation portion, a second modulation portion and a third modulation portion; a selected refractive index is one of a first refractive index, a second refractive index and a third refractive index corresponding to the selected modulation portion. In the case where the first liquid crystal molecules rotate to the first stable state, among a plurality of selected refractive indexes of the selected modulation portion, a deflection angle β is formed between an output light corresponding to a larger selected refractive index and an output light corresponding to a smaller selected refractive index; the deflection angle β satisfies a formula:

$$β = arcsin ( \frac{{n}_{0} * ( {n}_{0} - {n}_{1} ) d}{{n}_{1} \sqrt{{( {n}_{0} - {n}_{1} )}^{2} * {d}^{2} + {r}_{1}^{2}}} )$$

where n₀ is an extraordinary refractive index of first liquid crystal molecules corresponding to the smaller selected refractive index, n₁ is an ordinary refractive index of the first liquid crystal molecules, d is a thickness of the liquid crystal layer, and r₁ is a width of the selected modulation portion in the first direction.

In some embodiments, in the case where the first liquid crystal molecules rotate to the first stable state, the light modulation unit is divided into a plurality of fourth modulation portions and a plurality of fifth modulation portions that are alternately arranged in the first direction. A fourth modulation portion has a fourth refractive index, and a fifth modulation portion has a fifth refractive index. The fourth refractive index is greater than the fifth refractive index. A difference between phase retardation of two adjacent fourth modulation portions is 2π.

In some embodiments, there exist two control electrode layers, and control electrodes of a control electrode layer farther away from the liquid crystal layer includes a third electrode, and a control electrode layer closer to the liquid crystal layer includes two fourth electrodes adjacent to the third electrode. In a case where the first liquid crystal molecules rotate to the first stable state, a control voltage applied to the third electrode is a first voltage, voltages applied to the two fourth electrodes are a second voltage and a third voltage respectively, and the second voltage is greater than the third voltage. The first voltage is greater than the third voltage, and less than the second voltage, or the first voltage is equal to the second voltage, or the first voltage is equal to the third voltage.

In yet another aspect, a display apparatus is provided. The display device includes the light modulation module as described in any one of the above embodiments and a display substrate. The light modulation module is connected to the display substrate.

In some embodiments, the display substrate is any one of an OLED display substrate, an LED display substrate, a micro LED display substrate and a mini LED display substrate; and the light modulation module is disposed on a light exit side of the display substrate.

In some embodiments, the display substrate is an LCD display substrate. The display apparatus further includes a backlight module. The backlight module is disposed on a side of the display substrate away from the backlight module, or the light modulation module is disposed between the display substrate and the backlight module.

In some embodiments, the display apparatus is a dual-view display apparatus or a privacy protection display apparatus.

In still yet another aspect, a light-emitting apparatus is provided. The display device includes the light modulation module as described in any one of the above embodiments and a light-emitting substrate. The light modulation module is disposed on a light exit side of the light-emitting substrate and connected to the light-emitting substrate.

### BRIEF DESCRIPTION OF THE DRAWINGS

In order to describe technical solutions in some embodiments of the present disclosure more clearly, the accompanying drawings to be used in some embodiments of the present disclosure will be introduced briefly; obviously, the accompanying drawings to be described below are merely some embodiments of the present disclosure, and a person of ordinary skill in the art can obtain other drawings according to those drawings.

In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a light modulation module, in accordance with some embodiments;

FIG. 2 is a curve diagram showing a change of a rotation angle of a first liquid crystal molecule as a driving voltage, in accordance with some embodiments;

FIG. 3 is a diagram showing an arrangement of touch electrodes, in accordance with some embodiments;

FIG. 4 is a diagram showing another arrangement of touch electrodes, in accordance with some embodiments;

FIG. 5 is a structural diagram of a light modulation module, in accordance with some embodiments;

FIG. 6 is a curve diagram showing phase distribution, in accordance with some other embodiments;

FIG. 7 is a structural diagram of another light modulation module, in accordance with some embodiments;

FIG. 8 is a structural diagram of yet another light modulation module, in accordance with some embodiments;

FIG. 9 is a structural diagram of yet another light modulation module, in accordance with some embodiments;

FIG. 10 is a structural diagram of yet another light modulation module, in accordance with some embodiments;

FIG. 11 is a structural diagram of yet another light modulation module, in accordance with some embodiments;

FIG. 12 is a structural diagram of yet another light modulation module, in accordance with some embodiments;

FIG. 13 is a structural diagram of yet another light modulation module, in accordance with some embodiments;

FIG. 14 is a structural diagram of yet another light modulation module, in accordance with some embodiments;

FIG. 15 is a diagram showing a refractive index distribution of a light modulation module, in accordance with some embodiments;

FIG. 16 is a diagram showing a refractive index distribution of another light modulation module, in accordance with some embodiments;

FIG. 17 is a diagram showing a refractive index distribution of yet another light modulation module, in accordance with some embodiments;

FIG. 18 is a diagram showing a refractive index distribution of yet another light modulation module, in accordance with some embodiments;

FIG. 19 is a diagram showing a refractive index distribution of yet another light modulation module, in accordance with some embodiments;

FIG. 20 is a diagram showing a refractive index distribution of yet another light modulation module, in accordance with some embodiments;

FIG. 21 is a structural diagram of yet another light modulation module, in accordance with some embodiments;

FIG. 22 is a structural diagram of a display apparatus, in accordance with some embodiments;

FIG. 23 is a diagram showing a refractive index distribution of yet another light modulation module, in accordance with some embodiments;

FIG. 24 is a simulation diagram of light rays, in accordance with some embodiments;

FIG. 25 is a structural diagram of a display apparatus, in accordance with yet some other embodiments;

FIG. 26 is a structural diagram of another display apparatus, in accordance with some embodiments;

FIG. 27 is a light trace diagram of a display apparatus, in accordance with some embodiments;

FIG. 28 is a light trace diagram of another display apparatus, in accordance with yet some other embodiments;

FIG. 29 is a light trace diagram of yet another display apparatus, in accordance with yet some other embodiments;

FIG. 30 is a light trace diagram of yet another display apparatus, in accordance with yet some other embodiments;

FIG. 31 is a light trace diagram of yet another display apparatus, in accordance with yet some other embodiments;

FIG. 32 is a diagram showing a refractive index distribution of yet another light modulation module, in accordance with some embodiments;

FIG. 33 is a diagram showing light incidence of a light modulation module, in accordance with some embodiments;

FIG. 34 is a curve diagram showing phase distribution, in accordance with yet some other embodiments;

FIG. 35 is a structural diagram of yet another display apparatus, in accordance with yet some other embodiments;

FIG. 36 is a structural diagram of yet another display apparatus, in accordance with yet some other embodiments;

FIG. 37 is a structural diagram of yet another display apparatus, in accordance with yet some other embodiments; and

FIG. 38 is a structural diagram of a light-emitting apparatus, in accordance with some embodiments.

### DESCRIPTION OF THE INVENTION

The technical solutions in some embodiments of the present disclosure will be described clearly and completely with reference to the accompanying drawings; obviously, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example”, or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

The terms “first” and “second” are used for descriptive purposes only, and are not to be construed as indicating or implying a relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

In the description of some embodiments, the expressions “coupled”, “connected”, and derivatives thereof may be used. The term “connected” should be understood in a broad sense. For example, the term “connected” may represent a fixed connection, a detachable connection, or a one-piece connection, or may represent a direct connection, or may represent an indirect connection through an intermediate medium. The term “coupled” indicates that two or more components are in direct physical or electrical contact with each other. The term “coupled” or “communicatively coupled” may also mean that two or more components are not in direct contact with each other but still cooperate or interact with each other. The embodiments disclosed herein are not necessarily limited to the content herein.

The phrase “at least one of A, B, and C” has the same meaning as the phrase “at least one of A, B, or C”, both including the following combinations of A, B, and C: only A, only B, only C, a combination of A and B, a combination of A and C, a combination of B and C, and a combination of A, B, and C.

The phrase “A and/or B” includes following three combinations: only A, only B, and a combination of A and B.

The use of “applicable to” or “configured to” herein indicates an open and inclusive expression, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values other than those stated.

The term such as “about”, “substantially”, or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel”, “perpendicular”, or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; the term “equal” includes absolute equality and approximate equality, and an acceptable range of deviation of the approximate equality may be that, for example, a difference between the two that are equal is less than or equal to 5% of either of the two.

It should be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views that are schematic illustrations of idealized embodiments. In the accompanying drawings, thicknesses of layers and sizes of regions are enlarged for clarity. Thus, variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a curved feature. Therefore, the regions shown in the accompanying drawings are schematic in nature, and their shapes are not intended to show actual shapes of the regions in a device, and are not intended to limit the scope of the exemplary embodiments.

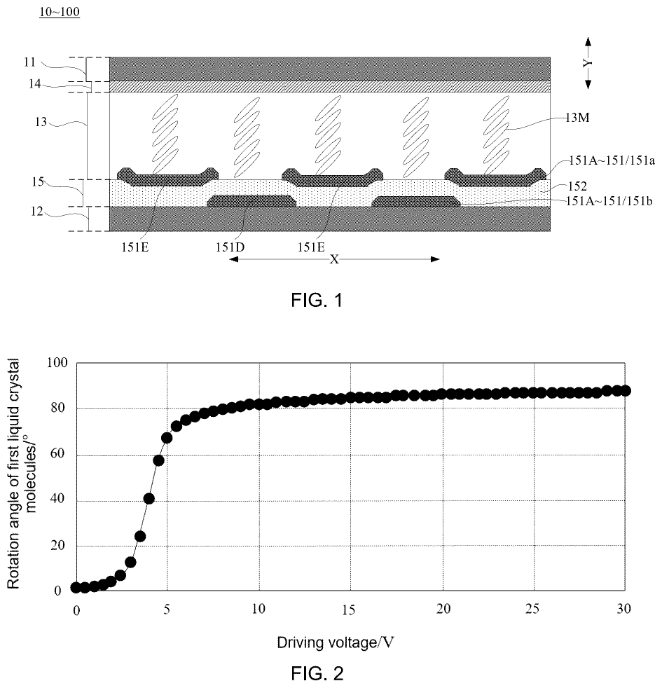

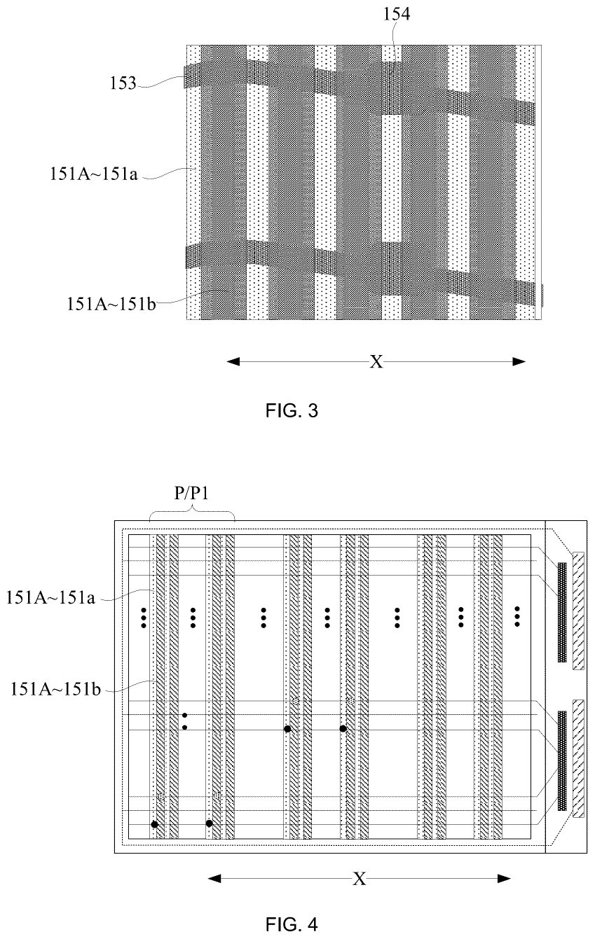

It will be noted that, for example, a sign “11˜1” shown in the drawings of the present disclosure indicates that the component 11 belongs to the component 1; for example, a sign “151A˜151a” in FIG. 3 indicates that the control electrode 151A belongs to the control electrode layer 151a. Other similar signs appearing in the drawings also follow the above description. A sign, for example, “½” shown in the drawings of the present disclosure indicates that the structure 1 and the structure 2 may both refer to this structure. For example, a sign “151/151a” in FIG. 1 indicates that the control electrode layer 151 and the control electrode layer 151a may both refer to this structure. Other similar signs appearing in the drawings also follow the above description.

Display apparatuses (e.g., mobile phones, computers, televisions or car display devices) are used everywhere. In conventional application scenarios, display apparatuses generally pursue viewing at multiple angles and without color shift at a wide viewing angle. However, with the development of information display technology, various new display demands and applications emerge in an endless stream. For some special application scenarios, due to the growing requirements for confidentiality, the demand for reducing the viewing angle is increasing. For example, when it is necessary to view personal privacy information on electronic devices such as mobile phones in public, there is a need to prevent people around from viewing the relevant information from a side view. For another example, when the co-pilot display device is used for entertainment while the vehicle is driving, the driver may be distracted and thus face safety risks. Therefore, if it is possible to achieve a wide viewing angle display effect and switch to a narrow viewing angle at any time to achieve a privacy protection effect, the application scenarios of the display apparatus will be further broadened.

In some embodiments, the privacy protection effect is achieved by adjusting brightness by tracking the human eye, mainly by capturing the human iris at the peeping angle, or tracking the geometric feature of the human eye for feedback, and adjusting parameters such as voltage, so as to reduce the overall transmittance of the display apparatus. In this way, the privacy protection function may be controlled accurately. However, the overall change in the brightness of the display apparatus may affect the display effect within a normal viewing angle and affect the viewing experience.

In some other embodiments, the privacy protection effect is achieved by connecting (for example, by bonding or physical buckle) a privacy protection film to the light-emitting surface of the display apparatus. For example, the privacy film may adopt ultra-fine louver optical coating technology to minimize the obstruction of light at the normal viewing angle of the screen to enable the screen to have a high transmittance, thereby achieving the purpose of privacy protection. However, as the angle increases, the area where light is blocked increases and the transmittance gradually decreases. Moreover, due to the limitations of the optical structure, the transmittance of the display apparatus will be reduced, and in general the loss rate of the transmittance is nearly 50%. In some examples, the backlight brightness is increased to meet normal display brightness requirements, which results in an increase in the operating power consumption of the display apparatus and a decrease in the usage time of the display apparatus. In addition, since the material and surface treatment process of the privacy film are similar to those of the functional coating of the polarizer of the display apparatus, the additional application of the privacy film may not only increase the weight of the display apparatus, but may also affect other display specifications including haze.

In light of this, some embodiments of the present disclosure provide a light modulation module to ameliorate one or more of the above problems. As shown in FIG. 1, the light modulation module 100 includes at least one light modulation unit 10. The light modulation unit 10 includes a first substrate 11 and a second substrate 12 that are assembled together, a liquid crystal layer 13, a common electrode layer 14, and a control electrode sub-module 15. The liquid crystal layer 13 is located between the first substrate 11 and the second substrate 12, and the liquid crystal layer 13 includes first liquid crystal molecules 13M. The common electrode layer 14 is located between the first substrate 11 and the liquid crystal layer 13. The control electrode sub-module 15 is located between the second substrate 12 and the liquid crystal layer 13. The control electrode sub-module 15 includes at least two control electrode layers 151 and a dielectric layer 152 located between two adjacent control electrode layers 151. Each control electrode layer 151 includes a plurality of control electrodes 151A arranged at intervals in a first direction X. Orthographic projections of control electrodes 151A included in any two control electrode layers 151 on the second substrate 12 are staggered in the first direction X; for orthographic projections of control electrodes 151A included in the at least two control electrode layers 151 on the second substrate 12, adjacent orthographic projections are connected.

Herein, the first substrate 11 and the second substrate 12 may be made of a same material, e.g., glass, or may be made of different materials, which is not limited in the embodiments of the present disclosure.

In some embodiments, the light modulation unit 10 further includes a sealing structure (not shown in the figure) for causing the first substrate 11 and the second substrate 12 to be assembled together; for example, the sealing structure may be disposed on a side surface of the liquid crystal layer 13 to prevent the first liquid crystal molecules 13M in the liquid crystal layer 13 from flowing out of the light modulation unit 10. In this case, a material of the sealing structure is, for example, frame sealant.

It will be understood that the first liquid crystal molecules 13M are a type of liquid crystal molecules, which are uniaxial crystals and have only one optic axis. Here, an optic axis (e.g., the optic axis of the first liquid crystal molecule 13M) is also referred to as an optical axis. When light propagates in a crystal, a direction in which two orthogonal waves propagate at the same speed is an extension direction of the optical axis, and there is no change in optical properties of light in this direction. For example, anisotropic crystals have a birefringence effect on light propagating therein, but when the light propagates therein along the optical axis of the anisotropic crystal, the light does not undergo birefringence. Therefore, the optical axis of the anisotropic crystal may also be defined as a direction in which light capable of propagating without birefringence. In addition, anisotropic crystals may be classified into uniaxial crystals and biaxial crystals.

Liquid crystal molecules may be classified into rod-type liquid crystal molecules and discotic liquid crystal molecules according to the shape. For the rod-type liquid crystal molecules, the long axis direction is the optical axis direction; for the discotic liquid crystal molecules, the short axis direction is the optical axis direction. In a three-dimensional coordinate system, a material whose refractive indexes in at least two of the three coordinate axis directions are different is called a birefringent material, and the liquid crystal molecules are all birefringent materials. In some embodiments, the first liquid crystal molecules 13M in the liquid crystal layer 13 are all rod-type liquid crystal molecules.

In some examples, the first liquid crystal molecules 13M are polymer liquid crystals, and an alignment process may be performed on the polymer liquid crystals to modulate light of a specific polarization state. When no driving voltage is applied, the refractive index of polarized light passing through the liquid crystal layer 13 is the ordinary refractive index n₁, which is close to the refractive index of the polymer layer and has no focusing property. When a driving voltage is applied, the polarization direction of the incident light changes. In this case, the refractive index of the polarized light passing through the liquid crystal layer 13 is an extraordinary refractive index n₀, which is greater than the refractive index of the polymer layer, and behaves as a convex lens.

The first liquid crystal molecules 13M may rotate (for example, rotate in a plane perpendicular to the first direction X) due to the action of the driving voltage and deflect to a set rotation angle. Here, the rotation angle may be understood as an angle between the first liquid crystal molecules 13M and the second substrate 12 in a driving state. It will be understood that the rotation angle of the first liquid crystal molecules 13M may affect the refractive index of the first liquid crystal molecules 13M, and in turn affect the modulation effect of the liquid crystal layer 13 on light. Specifically, the electric field applied to the first liquid crystal molecules 13M may change the alignment direction of the first liquid crystal molecules 13M. When the incident light propagates in the first liquid crystal molecules 13M (e.g., a nematic liquid crystal material), its propagation speed depends on the optical anisotropy of the first liquid crystal molecules 13M and the incident angle and polarization state of the light. Based on Huygens' principle, every point on the wavefront generated by a light source may be regarded as a light source, which may reradiate spherical waves and generate new spherical waves. The wavefront passing through the liquid crystal layer 13 will change, causing the light waves to converge or diverge, which may correspond to the orthogonal distance and negative focal length of a traditional lens. That is, the light modulation unit 10 may utilize the voltage-dependent birefringence property of the first liquid crystal molecules 13M to achieve different phase retardation within the same propagation distance through different tilt angles (i.e., rotation angles) of the first liquid crystal molecules 13M. In some examples, the deflection of light by the light modulation unit 10 may be substantially equivalent to that of a common lens with the same phase retardation.

The first liquid crystal molecules 13M in the light modulation unit 10 may rotate different rotation angles due to the action of the electric field. In a case where the rotation angles of the first liquid crystal molecules 13M in various parts of the liquid crystal layer 13 are different, when the light passes through a modulation region of the light modulation unit 10, the effective extraordinary refractive index n₀ realized in each part in the modulation region is different, so that the light may be converted into a converging or diverging spherical wave, and the degree of deflection depends on the difference of (n_{c}-n_{b}), where n_{c} is the extraordinary refractive index at the center of the modulation region, and n_{b} is the extraordinary refractive index at the edge of the modulation region. According to the light transfer function, if the focal distance f is satisfy: f<0, the light converges; if the focal distance f is satisfy: f>0, the light diverges.

In some examples, a curve of a change in the rotation angle of the first liquid crystal molecule 13M with a driving voltage is shown in FIG. 2. As can be seen from FIG. 2, the rotation angle of the first liquid crystal molecule 13M is nonlinearly related to the driving voltage; after the driving voltage is higher than the threshold voltage (not shown in the figure), a voltage range of about 2 V appears, and within this voltage range, the rotation angle of the first liquid crystal molecule 13M may change rapidly with the driving voltage. Therefore, a suitable driving voltage value may be selected according to requirements to enable the first liquid crystal molecules 13M to reach a set rotation angle.

In some examples, the driving voltage (e.g., the voltage between the common electrode layer 14 and the control electrode 151A described in detail below) of the liquid crystal layer 13 is low, for example, less than a set voltage value. The set voltage value is, for example, a driving voltage value corresponding to 98% n₀ₘₐₓ, where n₀ₘₐₓ is the maximum ordinary refractive index. In this way, the driving voltage of the liquid crystal layer 13 is low, which may reduce the power consumption of the light modulation unit 10 and reduce the influence of the transverse electric field on the refractive index.

The control electrode sub-module 15 includes at least two control electrode layers 151 and a dielectric layer 152 between two adjacent control electrode layers 151, that is, the control electrode layers 151 and the dielectric layer(s) 152 are alternately stacked in a thickness direction Y of the liquid crystal layer 13. Here, the term “alternately stacked” means that, in the thickness direction Y of the liquid crystal layer 13, the at least two control electrode layers 151 and dielectric layers 152 are stacked and arranged in an alternating manner. For example, in the thickness direction Y of the liquid crystal layer 13, a control electrode layer 151 is first arranged, and then a dielectric layer 152 is arranged on the control electrode layer 151, and then another control electrode layer 151 is arranged on the dielectric layer 152, and the arrangement is repeated in the above manner to form the control electrode sub-module 15.

It will be understood that the dielectric layer 152 may play an insulating role. The control electrode layers 151 and the dielectric layer(s) 152 are alternately stacked, which may avoid the problems such as short circuit between two adjacent control electrode layers 151, thereby improving the reliability of the control electrode sub-module 15.

Each control electrode layer 151 includes a plurality of control electrodes 151A arranged at intervals. By arranging the plurality of control electrodes 151 at intervals, the problems such as short circuit between two adjacent control electrodes 151A may be avoided.

In some examples, as shown in FIG. 1, the material of the dielectric layer 152 is filled between a plurality of control electrodes 151A of the same control electrode layer 151. In this case, the dielectric layer 152 plays an insulating role.

With the above-mentioned arrangement, it is possible to achieve the insulation between two adjacent control electrode layers 151 and between a plurality of control electrodes 151A located in the same control electrode layer 151, which may avoid the short circuit between the control electrodes 151A located in two adjacent control electrode layers 151 and the short circuit between the plurality of control electrodes 151A located in the same control electrode layer 151, so that the crosstalk between the control electrodes 151A may be avoided. Moreover, compared with the case where a single-layer electrode is provided, the influence of process limitations on the arrangement of the control electrodes 151A may be reduced by providing the control electrode sub-module 15 to include a plurality of control electrode layers 151.

Here, the sizes of the multiple control electrodes 151A in the same control electrode layer 151 or in different control electrode layers 151 are not limited. That is, the multiple control electrodes 151A may be the same or different.

Here, the materials of the control electrode 151A and the common electrode layer 14 may be the same, for example, both are indium tin oxide (ITO), and the materials may also be different, which is not limited here.

In some examples, the material of the control electrode 151A and/or the common electrode layer 14 may be a transparent material, in which case optical loss during the modulation process may be reduced. In some other examples, the material of the control electrode 151A and/or the common electrode layer 14 may be a metal material.

It will be noted that, in practical applications, light may be incident from the first substrate 11 and emitted from the second substrate 12; alternatively, light may be incident from the second substrate 12 and emitted from the first substrate 11; that is, there is no limitation on the emission side (or incident side) of the light.

As shown in FIGS. 1, 3 and 4, the plurality of control electrodes 151A included in the control electrode layer 151 are arranged at intervals in the first direction X, and the orthographic projections of the multiple control electrodes 151A included in any two control electrode layers 151 on the second substrate 12 are staggered in the first direction X; it may be understood that, in at least two control electrode layers 151, there are arbitrarily selected first control electrode layer 151a and second control electrode layer 151b, and the orthographic projections of the plurality of control electrodes 151A included in the first control electrode layer 151a on the second substrate 12 do not completely overlap with the orthographic projections of the plurality of control electrodes 151A included in the second control electrode layer 151b on the second substrate 12; it may also be understood that the orthographic projections of any two control electrode layers 151 on the second substrate 12 do not completely overlap.

As a possible implementation, as shown in FIGS. 1, 3 and 4, the number of control electrode layers 151 is two, and the orthographic projections of the multiple control electrodes 151A of the two control electrode layers 151 on the second substrate 12 are alternately arranged in the first direction X.

In some examples, the orthographic projections of any two control electrode layers 151 on the second substrate 12 may partially overlap. Here, the form in which the orthographic projections of the two control electrode layers 151 (e.g., the first control electrode layer 151a and the second control electrode layer 151b) on the second substrate 12 partially overlap is not limited. For example, a portion (e.g., one or more) of the plurality of control electrodes 151A included in the first control electrode layer 151a coincides with a portion (e.g., one or more) of the plurality of control electrodes 151A included in the second control electrode layer 151b. For another example, as shown in FIGS. 1, 3 and 4, a portion (e.g., one or more) of the plurality of control electrodes 151A included in the first control electrode layer 151a partially overlaps with a portion (e.g., one or more) of the plurality of control electrodes 151A included in the second control electrode layer 151b.

As shown in FIG. 1, for the orthographic projections of the multiple control electrodes 151A included in at least two control electrode layers 151 on the second substrate 12, adjacent orthographic projections are connected; that is, for the orthographic projections of the control electrodes 151A included in the control electrode sub-module 15 on the second substrate 12, there is no gap between adjacent orthographic projections. It will be understood that in a case where there is no gap between adjacent orthographic projections, the orthographic projections of the multiple control electrodes 151A included in the control electrode sub-module 15 on the second substrate 12 may be pieced together into a continuous and gap-free region.

Here, there is no limitation on the form of connection between the adjacent orthographic projections. In some examples, the adjacent orthographic projections may be connected by sharing a common border. In other words, a border of one orthographic projection is reused as a border of another orthographic projection. In this case, the adjacent orthographic projections are connected but do not overlap. In some other examples, the adjacent orthographic projections may be connected by partially overlapping. In this case, the adjacent orthographic projections are connected and partially overlap.

In some examples, as shown in FIGS. 3 and 4, the light modulation module 100 further includes a connection line 153, and the control electrode 151A is electrically connected to the connection line 151A through a conductive material 154 filled in the via hole. Here, the connection line 153 and the conductive material 154 may be configured to provide a driving signal for the control electrode 151A.

It will be understood that, in the case where the common electrode layer 14 is located between the first substrate 11 and the liquid crystal layer 13, the common electrode layer 14 may be configured to apply a common voltage from a side of the liquid crystal layer 13 proximate to the first substrate 11; in the case where the control electrode sub-module 15 is located between the second substrate 12 and the liquid crystal layer 13, the control electrode 151A may be configured to apply a control voltage from a side of the liquid crystal layer 13 proximate to the second substrate 12. In this way, a driving voltage may be generated through the common voltage and the control voltage, so that the first liquid crystal molecules 13M located between the control electrode 151A and the common electrode layer 14 rotate (for example, rotate from the initial state to the first stable state as described in detail below) due to the driving of the driving voltage. Moreover, in a case where there is no crosstalk between the multiple control electrodes 151A located in two adjacent control electrode layers 151 and between the plurality of control electrodes 151A located in the same control electrode layer 151, different control voltages may be input to the multiple control electrodes 151A to generate different driving voltages. In this way, due to the driving of different driving voltages, the liquid crystal layer 13 may be divided into a plurality of independent driving regions, and the rotation angles of the first liquid crystal molecules 13M in different driving regions may be the same or different, thereby realizing differentiated modulation for the light passing through different positions of the liquid crystal layer 13 to realize the function of controllable light modulation. For example, it is possible to modulate the light exit angle to be deflected towards a direction away from the viewing position to achieve the privacy protection function. Moreover, with the above arrangement, the driving voltage of the multiple control electrodes 151A may be adjusted, so that the size of the modulation aperture P (which may be understood as a modulation region of the light modulation unit 10) and the distance between different modulation apertures P may be flexibly changed, so as to realize flexible and controllable modulation of light.

Furthermore, in a case where the orthographic projections of the multiple control electrodes 151A included in the control electrode sub-module 15 on the second substrate 12 are pieced together into a continuous and gapless region, the driving regions corresponding to the various control electrodes 151A may be made continuous and gapless, making the electric field for driving the rotation of the first liquid crystal molecules 13M more continuous, thereby reducing the fluctuation deviation of the phase retardation. In addition, in a case where two control electrodes 151A cover each other, for example, partially or completely cover each other, the control electrode 151A away from the liquid crystal layer 13 will be shielded by the control electrode 151A proximate to the liquid crystal layer 13. Therefore, in the case where the orthographic projections of the multiple control electrodes 151A included in any two control electrode layers 151 on the second substrate 12 are staggered in the first direction X, more portions of the multiple control electrodes 151A may be effectively input with the control voltage.

Here, there is no limitation on the relationship between the orthographic projection of the multiple control electrodes 151A of the control electrode sub-module 15 on the second substrate 12 and the orthographic projection of the liquid crystal layer 13 on the second substrate 12. For example, as shown in FIGS. 1, 3 and 4, part or all of the orthographic projections of the multiple control electrodes 151A of the control electrode sub-module 15 on the second substrate 12 may cover the orthographic projection of the liquid crystal layer 13 on the second substrate 12. In this case, all parts of the liquid crystal layer 13 can be driven; for another example, part or all of the orthographic projections of the multiple control electrodes 151A of the control electrode sub-module 15 on the second substrate 12 may cover part of the orthographic projection of the liquid crystal layer 13 on the second substrate 12. In this case, part of the liquid crystal layer 13 can be driven, while the other part cannot be driven.

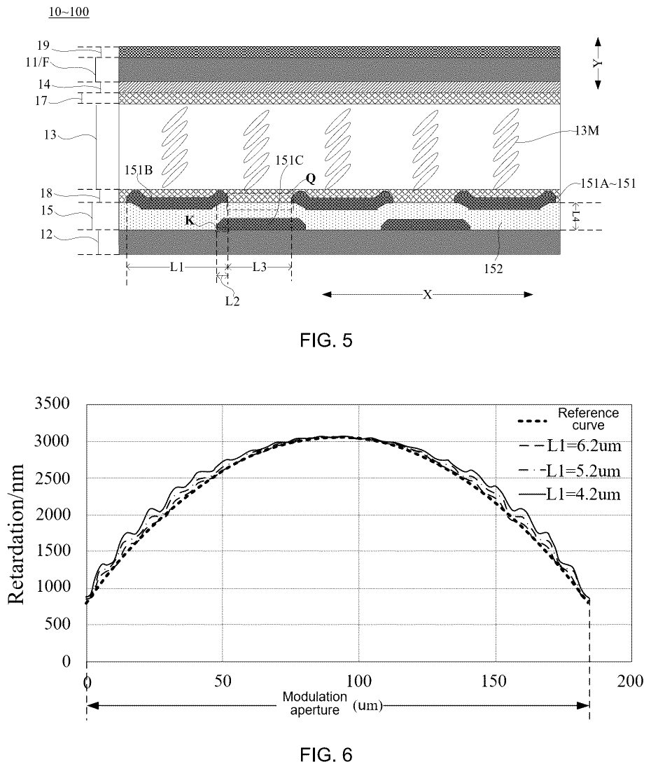

In some embodiments, as shown in FIG. 5, the control electrodes 151A of the at least two control electrode layers 151 include a first electrode 151B and a second electrode 151C. The orthographic projections of the first electrode 151B and the second electrode 151C on the second substrate 12 are adjacently arranged. The orthographic projections of the first electrode 151B and the second electrode 151C on the substrate 12 have a first overlapping portion K.

It will be noted that the “first” and “second” in the first electrode 151B and the second electrode 151C are relative concepts and are only used for descriptive purposes to make the relative position relationship of the orthographic projections of the two control electrodes 151A adjacent clear. In actual applications, the first electrode 151B and the second electrode 151C may be any two control electrodes 151A whose orthographic projections adjacent among the multiple control electrodes 151A, and depending on the position of the control electrode 151A described, a certain control electrode 151A may be either the first electrode 151B or the second electrode 151C.

It will be understood that, in the case where the control electrode layer 151 includes a plurality of control electrodes 151A arranged at intervals, the first electrode 151B and the second electrode 151C are located in different control electrode layers 151.

The first overlapping portion K is a part where the orthographic projection of the first electrode 151B on the second substrate 12 overlaps with the orthographic projection of the second electrode 151C on the second substrate 12; that is, the first overlapping portion K is a part of a surface of the second substrate 12 proximate to the control electrode sub-module 15.

It can be understood that in the case where the orthographic projection of the first electrode 151B on the second substrate 12 and the orthographic projection of the second electrode 151C on the second substrate 12 have a first overlapping portion K, there is a first overlapping portion K between the orthographic projections of any two control electrodes 151A adjacent to each other. In this way, compared with the case where the orthographic projections are spaced apart, the electric field driving the rotation of the first liquid crystal molecules 13M may be made more continuous, so that the fluctuation deviation of the phase retardation may be reduced; moreover, the process feasibility of forming multiple control electrodes 151A may be improved, and the production yield when producing the light modulation unit 10 may be improved.

In some embodiments, as shown in FIG. 5, a dimension of the control electrode 151A in the first direction X is a first width L1, and a dimension of the first overlapping portion K in the first direction X is a second width L2; a ratio of the second width L2 to the first width L1 is in a range of 2% to 10%, inclusive.

For example, the ratio of the second width L2 to the first width L1 may be 2%, 4%, 5%, 7%, 9% or 10%, etc. For example, the first width L1 is 5.2 μm, the second width L2 is 0.5 μm, and the ratio of the second width L2 to the first width L1 is 9.6%.

It can be understood that in the case where the dimension of the control electrode 151A in the first direction X is the first width L1, the dimensions of the multiple control electrodes 151A located in at least two control electrode layers 151 in the first direction X are the same. In this way, the area of the driving region may be relatively consistent, so that the controllability of the light modulation unit 10 when modulating light may be improved; furthermore, in a case where a certain control electrode 151A is small, the spacing between the control electrodes 151A on both sides thereof will be small, resulting in a lateral electric field, which affects the light modulation effect. Therefore, by setting the dimension of the control electrode 151A in the first direction X to the first width L1, the light modulation effect may be improved.

Moreover, in a case where the ratio of the second width L2 to the first width L1 is in a small range (for example, less than 2%), the continuity of the electric field driving the first liquid crystal molecule 13M to rotate is relatively low; in a case where the ratio of the second width L2 to the first width L1 is in a large range (for example, less than 10%), the portion of the multiple control electrodes 151A for effectively inputting the control voltage is small. Therefore, by setting the ratio of the second width L2 to the first width L1 in the range of 2% to 10%, firstly, the electric field driving the rotation of the first liquid crystal molecules 13M may be made more continuous, thereby reducing the fluctuation deviation of the phase delay amount; secondly, more portions of the multiple control electrodes 151A may be effectively input with the control voltage.

In some embodiments, as shown in FIG. 5, a dimension of the control electrode 151A in the first direction X is a first width L1. Among the plurality of control electrodes 151A of the control electrode layer 151, two adjacent control electrodes 151A have a first gap Q therebetween. A dimension of the first gap Q in the first direction X is a third width L3. A ratio of the first width L1 to the third width L3 is greater than or equal to 50% and less than or equal to 80%.

For example, the ratio of the first width L1 to the third width L3 may be 50%, 55%, 60%, 65%, 69%, 75%, 80%, etc.

Regarding the technical effects that can be achieved in the case where the dimension of the control electrode 151A in the first direction X is the first width L1, reference may be made to the above content and will not be repeated here.

It can be understood that in the case where the ratio of the first width L1 to the third width L3 is greater than or equal to 50% and less than or equal to 80%, the ratio of the first width L1 to the third width L3 is great. Firstly, it is possible to avoid mutual influence between the control electrodes 151A caused by two adjacent control electrodes 151A located in the same control electrode layer 151 being too close to each other. Secondly, in a case where the adjacent control electrodes 151A are close to each other, the driving region corresponding to the control electrode 151A (located in another control electrode layer 151) whose orthographic projection is located between the adjacent control electrodes 151A is relatively small, resulting in some larger driving regions and some smaller driving regions, which will affect the stacked arrangement design of the control electrodes 151A. Therefore, with the above configuration, it is possible to reduce the influence on the stacked arrangement design of the control electrodes 151A, and moreover, the electric field distribution may be made more continuous, so that the imaging effect of the light modulation unit 10 is improved, and the production yield of the light modulation unit 10 may be improved.

In some examples, the effect of the dimension of the control electrode 151A in the first direction X on the phase retardation is verified by using a single-layer electrode structure. Here, a single-layer electrode means that a plurality of electrodes are distributed in the same electrode layer, and two adjacent electrodes have a gap therebetween. Moreover, in this test, the same driving method as that of the light modulation unit 10 in some embodiments of the present disclosure is adopted.

After testing, within a modulation aperture (which may be understood as a modulation region of a light modulation unit), under different first widths L1 (L1=4.2 μm, 5.2 μm, or 6.2 μm), the phase distribution curve is shown in FIG. 6. As can be seen from FIG. 6, the dimension (i.e., the first width L1) of the control electrode 151A in the first direction X will have a certain influence on the phase retardation. Moreover, under the same other conditions, compared with the case where the first width L1 is small, in the case where the first width L1 is great (L1=6.2 μm), the electric field distribution is more continuous, and the phase distribution curve is closer to the reference curve. Here, the reference curve may be understood as the curve corresponding to the lens with the same phase retardation.

In some embodiments, as shown in FIGS. 1 and 4, as described above, the light modulation unit 10 is divided into a plurality of modulation apertures P (e.g., first modulation portions described in detail below) when in a driving state, and each modulation aperture P may correspond to one or more of the above-mentioned driving regions.

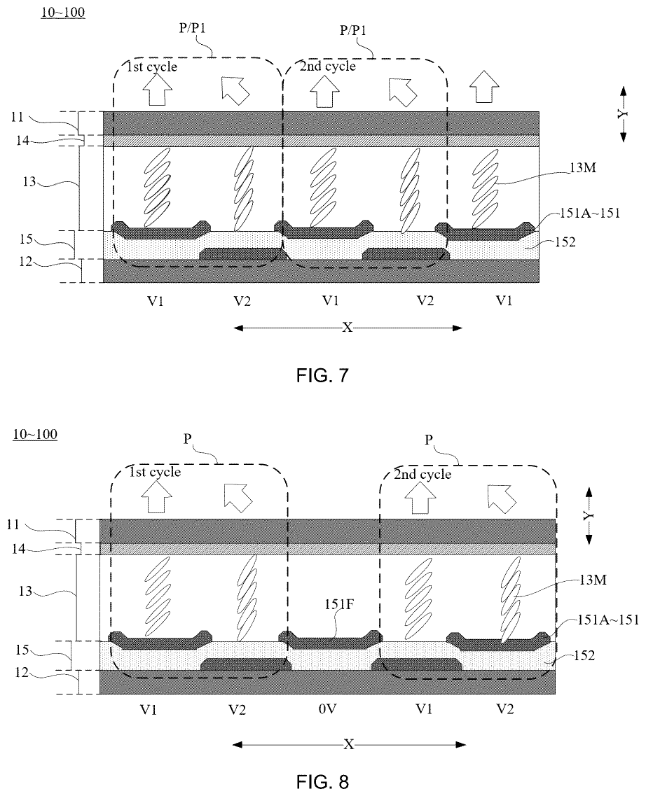

In some examples, as shown in FIG. 7, the plurality of modulation apertures P are arranged continuously without any gaps; in this case, the light modulation unit 10 may achieve an effect equivalent to that of a non-prism lens, and the influence between adjacent modulation apertures P is small. Moreover, in this case, two adjacent modulation apertures P may share the same control electrode 151A at the junction.

In some other examples, in two adjacent modulation apertures P, the driving voltage of the control electrode 151A located at the edge of one modulation aperture P is high, generating a large lateral electric field, which has a great impact on the rotation of the first liquid crystal molecules 13M, resulting in partial light scattering at the edge of the modulation aperture P.

Based on the above situation, as shown in FIG. 8, in some embodiments, a dummy control electrode 151F is provided between adjacent modulation apertures P for providing a gap. Thus, when the light modulation unit 10 modulates the light, the driving voltage of the dummy control electrode 151F is 0 V, which is used to shield the light scattering generated at the edge of the modulation aperture P due to the influence of the lateral electric field on the first liquid crystal molecules 13M.

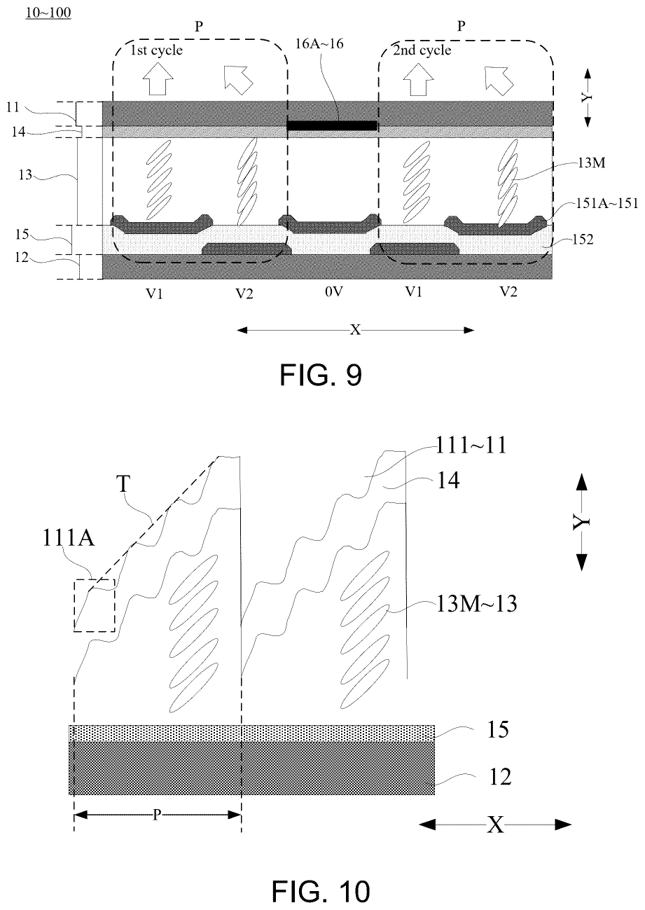

In some embodiments, as shown in FIG. 9, the light modulation unit 10 further includes a light-blocking layer 16. The light-blocking layer 16 includes a plurality of light-blocking patterns 16A arranged at intervals in the first direction X; an orthographic projection of a light-blocking pattern 16A on the second substrate 12 substantially coincides with an orthographic projection of at least one control electrode 151A on the second substrate 12.

For example, a material of the light-blocking layer 16 may be a black light-absorbing material, such as black ink, black glue, and black photoresist material.

In some examples, as shown in FIG. 9, an orthographic projection of a light-blocking pattern 16A on the second substrate 12 substantially coincides with an orthographic projection of a control electrode 151A on the second substrate 12. In some other examples, an orthographic projection of a light-blocking pattern 16A on the second substrate 12 substantially coincides with orthographic projections of multiple (e.g., two) control electrodes 151A on the second substrate 12.

It can be understood that the light-blocking pattern 16A may be arranged between two adjacent modulation apertures P to shield the light scattering generated at the edge of the modulation aperture P due to the influence of the lateral electric field on the first liquid crystal molecules 13M. In this way, it is possible to reduce the influence of stray light on the clarity of the picture, so that the clarity of the display picture modulated by the light modulation module 100 may be high. Moreover, in the case where an orthographic projection of a light-blocking pattern 16A on the second substrate 12 substantially coincides with an orthographic projection of at least one control electrode 151A on the second substrate 12, the at least one control electrode 151A may be blocked by the light-blocking pattern 16A. In this way, the number of control electrodes 151A within the modulation aperture P may be equal to or close to an integer, thereby improving the feasibility of light modulation.

It will be noted that when the light modulation unit 10 is in the light modulation state, the at least one control electrode 151A shielded by the light-blocking pattern 16A may or may not be input with a control voltage in the light modulation state, which is not limited here.

Herein, the position of the light-blocking layer 16 is not limited. In some examples, the light-blocking layer 16 is located between the liquid crystal layer 13 and the first substrate 11; for example, as shown in FIG. 9, the light-blocking layer 16 may be located between the common electrode layer 14 and the first substrate 11; for another example, the light-blocking layer 16 may be located between the liquid crystal layer 13 and the common electrode layer 14; for yet another example, the light-blocking layer 16 may be located on a side of the first substrate 11 away from the common electrode layer 14.

In some other examples, the light-blocking layer 16 is located between the liquid crystal layer 13 and the second substrate 12; for example, the light-blocking layer 16 may be located on a side of the second substrate 12 away from the control electrode sub-module 15; for another example, the light-blocking layer 16 may be located between the second substrate 12 and the control electrode sub-module 15; for yet another example, the light-blocking layer 16 may be located inside the control electrode sub-module 15 (for example, between the control electrode layer 151 and the dielectric layer 152); for yet another example, the light-blocking layer 16 may be located between the control electrode sub-module 15 and the liquid crystal layer 13.

In some embodiments, as shown in FIG. 10, a surface of the first substrate 11 proximate to the liquid crystal layer 13 has a plurality of protrusions 111; and the common electrode layer 14 has a shape consistent with a shape of the plurality of protrusions 111.

It will be understood that in the case where the surface of the first substrate 11 proximate to the liquid crystal layer 13 has a plurality of protrusions 111, the surface of the first substrate 11 proximate to the liquid crystal layer 13 is uneven and has certain undulations, presenting a certain three-dimensional texture pattern.

Here, the common electrode layer 14 has a shape consistent with the shape of the multiple protrusions 111, which means that the change in the surface morphology of the common electrode layer 14 is the same as the change in the surface morphology of the surface of the first substrate 11 proximate to the liquid crystal layer 13; in other words, the change in the surface morphology of the surface of the common electrode layer 14 proximate to the first substrate 11 and the change in the surface morphology of the surface of the common electrode layer 14 away from the first substrate 11 are both the same as the change in the surface morphology of the surface of the first substrate 11 proximate to the liquid crystal layer 13.

For example, as shown in FIG. 10, within a modulation aperture P, the surface of the first substrate 11 proximate to the liquid crystal layer 13 is provided with a step-like protrusion 111; then, within the modulation aperture P, the surface of the common electrode layer 14 proximate to the first substrate 11 has a step-like shape that matches the step-like shape of the protrusion 111, and the surface of the common electrode layer 14 away from the first substrate 11 has a step-like shape that matches the step-like shape of the protrusion 111. In this case, the common electrode layer 14 has a shape consistent with the shape of multiple protrusions 111.

It can be understood that when the light modulation unit 10 modulates the light, the phase retardation is associated with the refractive index of the first liquid crystal molecules 13M as well as the thickness of the liquid crystal layer 13 (also referred to as the cell thickness). In the case where the surface of the first substrate 11 proximate to the liquid crystal layer 13 has a plurality of protrusions 111, and the common electrode layer 14 has a shape consistent with the shape of the plurality of protrusions 111, the thickness of the liquid crystal layer 13 has a certain change. In this case, the light modulation unit 10 utilizes the rotation of the first liquid crystal molecules 13M to achieve phase retardation, and also utilizes the change in cell thickness to achieve phase retardation. Thus, when not powered on, the light modulation unit 10 utilizes the change in cell thickness to achieve phase retardation; when powered on, the light modulator 10 utilizes the change in cell thickness to expand the range of phase retardation that can be achieved by the light modulation unit 10.

It will be noted that, in the case where the surface of the first substrate 11 proximate to the liquid crystal layer 13 has a plurality of protrusions 111, there is no limitation on the surface of the first substrate 11 away from the liquid crystal layer 13 here. For example, the surface of the first substrate 11 away from the liquid crystal layer 13 has a shape consistent with the shape of the plurality of protrusions 111; in this case, the thickness of the first substrate 11 is uniform. For another example, the surface of the first substrate 11 away from the liquid crystal layer 13 is a plane; in this case, the thickness of the first substrate 11 is uneven.

In some embodiments, a surface of the second substrate 12 proximate to the liquid crystal layer 13 has a plurality of protrusions; the control electrode sub-module 15 has a shape consistent with the shape of the plurality of protrusions.

It will be understood that, in the case where the surface of the second substrate 12 proximate to the liquid crystal layer 13 has a plurality of protrusions, the surface of the second substrate 12 proximate to the liquid crystal layer 13 is uneven and has certain undulations, presenting a certain three-dimensional texture pattern.

Here, for understanding the shape of the control electrode sub-module 15 having a shape consistent with the plurality of protrusions, reference may be made to the above description of the shape of the common electrode layer 14 having a shape consistent with the plurality of protrusions 111, which will not be repeated here.

It can be understood that, in the case where the surface of the second substrate 12 proximate to the liquid crystal layer 13 has a plurality of protrusions, and the control electrode sub-module 15 has a shape consistent with the shape of the plurality of protrusions, the thickness of the liquid crystal layer 13 has a certain change. Thus, when not powered on, the light modulation unit 10 utilizes the change in cell thickness to achieve phase retardation; when powered on, the light modulation unit 10 utilizes the change in cell thickness to expand the range of phase retardation that can achieve by the light modulation unit 10.

It will be noted that, in the case where the surface of the second substrate 12 proximate to the liquid crystal layer 13 has a plurality of protrusions, there is no limitation on the surface of the second substrate 12 away from the liquid crystal layer 13 here. For example, the surface of the second substrate 12 away from the liquid crystal layer 13 may has a shape consistent with the shape of the plurality of protrusions; in this case, the thickness of the second substrate 12 is uniform; for another example, the surface of the second substrate 12 away from the liquid crystal layer 13 may be a plane; in this case, the thickness of the second substrate 12 is uneven.

Here, there is no limitation on the manner of forming a plurality of protrusions 111 on the surface of the first substrate 11 proximate to the liquid crystal layer 13, or the manner of forming a plurality of protrusions on the surface of the second substrate 12 proximate to the liquid crystal layer 13, as long as the requirement of having a plurality of protrusions is met.

In some examples, a nanoimprint process is used to form a plurality of protrusions on a surface of the first substrate 11 proximate to the liquid crystal layer 13 or a surface of the second substrate 12 proximate to the liquid crystal layer 13.

In some other examples, a plurality of protrusions are formed by coating a surface of the first substrate 11 proximate to the liquid crystal layer 13 or a surface of the second substrate 12 proximate to the liquid crystal layer 13 with a high barrier film.

In some embodiments, a surface of the protrusion proximate to the liquid crystal layer includes a plurality of sub-surfaces, and a sub-surface is directly opposite to one or more control electrodes. The plurality of sub-surfaces are arranged in a first shape, and the first shape includes one of a linear shape, a triangular shape, and a parabola shape or a combination of more of a linear shape, a triangular shape, and a parabola shape.

The following description is made by taking an example in which the plurality of protrusions 111 are provided on the surface of the first substrate 11 proximate to the liquid crystal layer 13. Regarding the situation that a plurality of protrusions are provided on the surface of the second substrate 12 proximate to the liquid crystal layer 13, reference is made to the following content, which will not be repeated here.

As shown in FIG. 10, the surface of the protrusion 111 proximate to the liquid crystal layer 13 includes a plurality of sub-surfaces 111A, and a sub-surface 111A is directly opposite to one or more control electrodes 151A. The plurality of sub-surfaces 111A are arranged in a first shape T, and the first shape T includes one of a linear shape, a triangular shape, and a parabola shape or a combination of more of a linear shape, a triangular shape, and a parabola shape.

Here, a sub-surface 111A is directly opposite to one or more control electrodes 151A, which means that an orthographic projection of a sub-surface 111A on the second substrate 12 substantially coincides with an orthographic projection of one or more control electrodes 151A on the second substrate 12.

In the following, considering an example in which the plurality of sub-surfaces 111A are arranged in the first shape T, and the first shape T includes a linear shape, the description will be made for a case that the plurality of sub-surfaces 111A are arranged in the first shape T, and the first shape T includes one of a linear shape, a triangular shape, and a parabola shape or a combination of more of a linear shape, a triangular shape, and a parabola shape.

In some examples, as shown in FIG. 10, the plurality of sub-surfaces 111A are arranged in a first shape T, and the first shape T includes a linear shape. For example, the surface of the protrusion 111 proximate to the liquid crystal layer 13 includes four sub-surfaces 111A, and by connecting corresponding points of the four sub-surfaces 111A, a linear first shape T may be obtained. That is, in FIG. 10, the surface of each protrusion 111 proximate to the liquid crystal layer 13 includes four sub-surfaces 111A, and each protrusion 111 may correspond to a line. It will be noted that connecting the corresponding points of each sub-surface 111A mentioned here refers to connecting the points with corresponding positions in all the sub-surfaces 111A; for example, the starting points of all the sub-surfaces 111A may be connected to obtain the first shape T; for another example, as shown in FIG. 10, the apices of all the sub-surfaces 111A may be connected to obtain the first shape T.

It can be understood that, in a case where the first shape T is a linear shape, the refractive index in the modulation aperture P corresponding to this portion changes linearly; in a case where the first shape T is a triangular shape, the refractive index in the modulation aperture P corresponding to this portion changes triangularly; in a case where the first shape T is a parabolic shape, the refractive index in the modulation aperture P corresponding to this portion changes parabolically. That is, by changing the first shape T, the cell thickness may be changed according to a set rule, so that the change of the refractive index in the modulation aperture P may be adjusted; in this way, the function of controllable modulation of light by the light modulation unit 10 may be realized.

In some embodiments, the plurality of protrusions include a plurality of rectangular protrusions, and two adjacent rectangular protrusions have a gap therebetween.

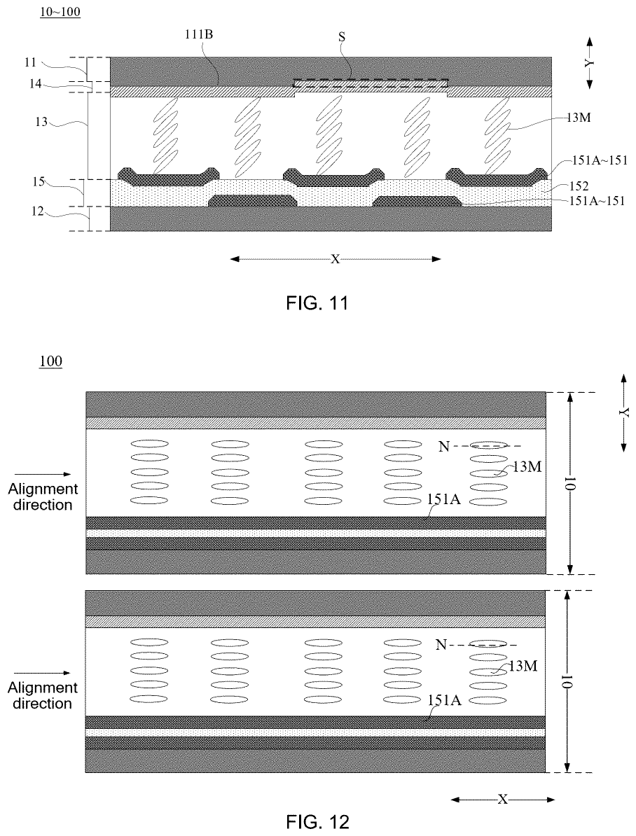

For example, as shown in FIG. 11, a plurality of protrusions 111 are disposed on a surface of the first substrate 11 proximate to the liquid crystal layer 13, and the plurality of protrusions 111 include a plurality of rectangular protrusions 1111B; two adjacent rectangular protrusions 111B have a gap S therebetween. For another example, a plurality of protrusions are disposed on a surface of the second substrate 12 proximate to the liquid crystal layer 13, and the plurality of protrusions 111 include a plurality of rectangular protrusions; two adjacent rectangular protrusions have a gap therebetween.

It can be understood that, the plurality of protrusions include a plurality of rectangular protrusions, and two adjacent rectangular protrusions have a gap therebetween, which may cause the cell thickness to change alternately in high and low order, so that the light modulation unit 10 may produce a modulation effect similar to a diffraction grating on the light. Furthermore, in the case where the cell thickness changes alternately in high and low order, by changing the driving voltage, the refractive index of the liquid crystal layer 13 may change alternately in a manner of which matches the change of the cell thickness. In this case, the above-mentioned diffraction grating-like modulation effect may be further improved, so that the function of changing the light exit angle and light brightness may be realized.

For example, the size of the gap may be set to a preset size, which may make the difference between the phase retardation of the liquid crystal layer 13 corresponding to the two rectangular protrusions located on both sides of the gap be 2π. In this way, the grating diffraction principle may be used to change the light exit angle and light brightness.

It will be noted that the surface of the first substrate 11 proximate to the liquid crystal layer 13 or the surface of the second substrate 12 proximate to the liquid crystal layer 13 may include only a plurality of rectangular protrusions, or may include only protrusions whose sub-surfaces are arranged in the first shape; alternatively, the surface of the first substrate 11 proximate to the liquid crystal layer 13 or the surface of the second substrate 12 proximate to the liquid crystal layer 13 may include both rectangular protrusions and protrusions whose sub-surfaces are arranged in the first shape. That is to say, according to actual needs, the rectangular protrusions and the protrusions whose sub-surfaces are arranged in the first shape may be combined.

In some examples, a portion of the surface of the first substrate 11 proximate to the liquid crystal layer 13 or a portion of the surface of the second substrate 12 proximate to the liquid crystal layer 13 includes rectangular protrusions; another portion of the surface of the first substrate 11 proximate to the liquid crystal layer 13 or another portion of the surface of the second substrate 12 proximate to the liquid crystal layer 13 includes protrusions whose sub-surfaces are arranged in a first shape, and the first shape corresponding to the protrusions may be one of linear, triangular and parabolic shapes or a combination of more of linear, triangular and parabolic shapes; in this way, a portion of the light modulation unit 10 corresponding to the rectangular protrusions may modulate the light using the grating diffraction principle; the protrusions whose sub-surfaces are arranged in the first shape may modulate the light by changing the refractive index of the liquid crystal layer 13. Thus, it is possible to achieve different modulation effects on different positions of the light modulation unit 10 (for example, the light is deflected, or the viewing angle is changed, such as converging or diverging the light).

In some embodiments, as shown in FIG. 5, the light modulation unit 10 further includes a first alignment film 17 and a second alignment film 18. The first alignment film 17 is located between the common electrode layer 14 and the liquid crystal layer 13. The second alignment film 18 is located between the control electrode sub-module 15 and the liquid crystal layer 13. In the case where the surface of the first substrate 11 proximate to the liquid crystal layer 13 has a plurality of protrusions, the first alignment film 17 has a shape consistent with the shape of the plurality of protrusions. In the case where the surface of the second substrate 12 proximate to the liquid crystal layer 13 has a plurality of protrusions, the second alignment film 18 has a shape consistent with the shape of the plurality of protrusions.

It will be understood that by providing a first alignment film 17 between the common electrode layer 14 and the liquid crystal layer 13 and providing a second alignment film 18 between the control electrode sub-module 15 and the liquid crystal layer 13, the first liquid crystal molecules 13M have a pretilt angle; here, the pretilt angle is an acute angle between the long axis N (referring to FIG. 12) of the first liquid crystal molecule 13M and a plane where the alignment film (the first alignment film 17 and/or the second alignment film 18) for aligning the first liquid crystal molecule 13M is located.

A pretilt angle may cause first liquid crystal molecules 13M to be in a pretilt state, and the pretilt state means that the liquid crystal molecules proximate to an alignment film (the first alignment film 17 and/or the second alignment film 18) are tilted in a specific direction relative to a plane where the alignment film is located. In some examples, the pretilt angle refers to an angle between the long axis of the rod-type liquid crystal molecules and the plane where the alignment film (the first alignment film 17 and/or the second alignment film 18) is located; a plane where the long axis of the rod-type liquid crystal molecules is located intersects with the plane where the alignment film (the first alignment film 17 and/or the second alignment film 18) is located. The pre-tilt angle of the first liquid crystal molecules 13M is a state of the first liquid crystal molecules 13M when the light modulation unit 10 is not powered on or when the a voltage between the control electrode 151A and the common electrode layer 14 is 0.

For example, the first alignment film 17 and/or the second alignment film 18 may be made of a polymer material; for example, the polymer material is polyimide (PI).

For example, the first alignment film 17, the second alignment film 18 may each be formed through a rubbing alignment process. During the rubbing process, the surfaces of the first alignment film 17 and the second alignment film 18 proximate to the liquid crystal layer 13 each form an oblique angle with respect to the respective surface thereof away from the liquid crystal layer 13. The alignment direction of the first alignment film 17 may be parallel and opposite to the alignment direction of the second alignment film 18, so that the alignment of the first liquid crystal molecules 13M in the liquid crystal layer 13 can be more consistent.

In some other examples, the first alignment film 17 and the second alignment film 18 may be formed by an optical alignment (OA) process.

For example, in the case where the first alignment film 17 and the second alignment film 18 are formed by a photoalignment process, the pretilt angle of the first liquid crystal molecule 13M may be reduced by at least 75% compared to the case of a rubbing process. In this way, in a case where the photoalignment process is adopted, a small driving voltage may be used to make the difference between the maximum refractive index and the minimum refractive index in a modulation aperture reach a set value. Thus, in a case where the difference between the maximum refractive index and the minimum refractive index in a modulation aperture needs to reach a set value (for example, when the light within a modulation aperture needs to be deflected by a certain angle), the photoalignment process is adopted to reduce the driving voltage of the light modulation unit 10, so that the power consumption of the light modulation unit 10 is low.

It can be understood that, the first alignment film 17 is configured to align a part of first liquid crystal molecules 13M proximate to the first alignment film 13M in the liquid crystal layer 13, and the second alignment film 18 is configured to align a part of first liquid crystal molecules 13M proximate to the second alignment film 18 in the liquid crystal layer 13, so as to achieve the alignment for the first liquid crystal molecules 13M. Moreover, in the case where the surface of the first substrate 11 proximate to the liquid crystal layer 13 has a plurality of protrusions, the first alignment film 17 is configured to have a shape consistent with the shape of the plurality of protrusions; and in the case where the surface of the second substrate 12 proximate to the liquid crystal layer 13 has a plurality of protrusions, the second alignment film 18 is configured to have a shape consistent with the shape of the plurality of protrusions. Thus, it is possible to make the thickness of the liquid crystal layer 13 have a certain change, so that the phase retardation may be achieved by utilizing the change in cell thickness.

In some examples, at least part of the light modulation unit 10 modulates light by using the grating diffraction principle. In this case, the part of the light modulation unit 10 that modulates light using the grating diffraction principle includes a plurality of high refractive index portions (e.g., a fourth modulation portion described in detail below) and a plurality of low refractive index portions (e.g., a fifth modulation portion described in detail below), and the plurality of high refractive index portions and the plurality of low refractive index portions are arranged alternately.

Based on the above situation, in some embodiments, as shown in FIG. 5, one of the first substrate 11 and the second substrate 12 of the light modulation unit 10 that is closer to the light exit side is a light exit substrate F; the light modulation unit further includes a linear polarizer 19 disposed on a surface of the light exit substrate F away from the liquid crystal layer 13.

It can be understood that by providing a linear polarizer 19 on the surface of the light exit substrate F away from the liquid crystal layer 13, the linear polarizer 19 may be used to filter the light emitted from the low refractive index portion, thereby reducing the crosstalk of the light emitted from the low refractive index portion and improving the light modulation effect of the light modulation unit 10.

In some embodiments, a thickness L4 of the dielectric layer 152 is less than or equal to 2500 Å.

For example, the thickness of the dielectric layer 152 may be 100 Å, 500 Å, 1000 Å, 1500 Å, 2000 Å, 2200 Å or 2500 Å.

It can be understood that in the case where the thickness L4 of the dielectric layer 152 is less than or equal to 2500 Å, the thickness of the dielectric layer 152 is relatively small. In this way, the distance between two adjacent control electrode layers 151 may be made small while ensuring the insulating effect of the dielectric layer 152, so that the continuity of the electric field of the two adjacent control electrode layers 151 may be improved.

In some embodiments, a difference Δn between the extraordinary refractive index n₀ of the first liquid crystal molecules 13M and the ordinary refractive index n₁ of the first liquid crystal molecules 13M is greater than or equal to 0.2.

For example, the difference between the extraordinary refractive index n₀ and the ordinary refractive index n₁ of the first liquid crystal molecule 13M may be 0.2, 0.3, 0.4, 0.5, 0.6, 0.7, 0.8, 0.9, 1.0, 1.05 or 1.2, etc.

It can be understood that in the case where the extraordinary refractive index n₀ is great, a light deflection angle β that can be achieved by the light modulation unit 10 is great (reference will be made to the calculation formula of the deflection angle β described in detail below); by setting the difference between the extraordinary refractive index n₀ and the ordinary refractive index n₁ of the first liquid crystal molecule 13M to be greater than or equal to 0.2, the extraordinary refractive index n₀ of the first liquid crystal molecule 13M may be made great, so that the light deflection angle β that can be achieved by the light modulation unit 10 may be made great, which may improve the light modulation effect of the light modulation unit 10.

In some embodiments, as shown in FIG. 12, there are a plurality of light modulation units 10, and the plurality of light modulation units 10 are stacked in a thickness direction Y of the liquid crystal layer 13. The arrangement directions of the control electrodes 151A of two adjacent light modulation units 10 are parallel.

In some examples, the light modulation unit 10 further includes an alignment film (e.g., a first alignment film and/or a second alignment film). In this case, the alignment film may be used to align the first liquid crystal molecules 13M of the two light modulation units 10, so that the alignment directions of the first liquid crystal molecules 13M of the two light modulation units 10 are parallel.

It can be understood that in a case where the arrangement directions of the control electrodes 151A of two adjacent light modulation units 10 are set in parallel, the two adjacent light modulation units 10 may modulate light of the same polarization state. In this way, compared with the case of one light modulation unit 10, the modulation efficiency of the two light modulation units 10 for the light of the polarization state is higher.

For example, in a case where the light modulation unit 10 modulates the light to enable the light to be deflected, and the control electrodes 151A of two light modulation units 10 are arranged in parallel, the deflection angle of the light may reach twice the deflection angle corresponding to one light modulation unit 10. Here, regarding the way in which the light modulation unit 10 realizes light deflection, reference will be made to in a part of a first modulation portion described below in which the multiple first refractive indices gradually decrease in the first direction and decrease linearly, or gradually increase in the first direction and increase linearly, which will not be repeated here.

In some examples, considering an 8.4-inch vehicle-mounted display apparatus equipped with light modulation module(s) as an example, under a different difference Δn (Δn=0, 0.2, 0.4, 0.6, 0.8) between the extraordinary refractive index n₀ and the ordinary refractive index n₁ of the first liquid crystal molecules 13M, the deflection angle that can be achieved by a single light modulation unit 10 and the deflection angle that can be achieved by two stacked light modulation units 10 (the arrangement directions of the control electrodes 151A of the two light modulation units 10 are arranged in parallel) are simulated, and the simulation results are shown in Table 1 below.

TABLE 1

| | Δn = | Δn = | Δn = | Δn = | Δn = |
|---|---|---|---|---|---|
| | 0 | 0.2 | 0.4 | 0.6 | 0.8 |
| Simulated deflection | 0° | 5° | 12° | 20° | 30° |
| angle of a single | | | | | |
| light modulation unit | | | | | |
| Simulated deflection | 0° | 10° | 23° | 40° | 66° |
| angle of two stacked | | | | | |
| light modulation unit | | | | | |

It can be seen from Table 1 that, when the light in a polarization state is modulated by two light modulation units 10, the simulated deflection angle of the may be twice that when it is modulated by a single light modulation unit 10; that is, the simulated deflection angle is close to the calculated deflection angle.

Moreover, it can be seen from Table 1 that, in a case where the number of light modulation units 10 is the same, a great deflection angle may be achieved when Δn is great. It can be seen that in the case where Δn is great, the light modulation effect of the light modulation unit 10 may be improved.

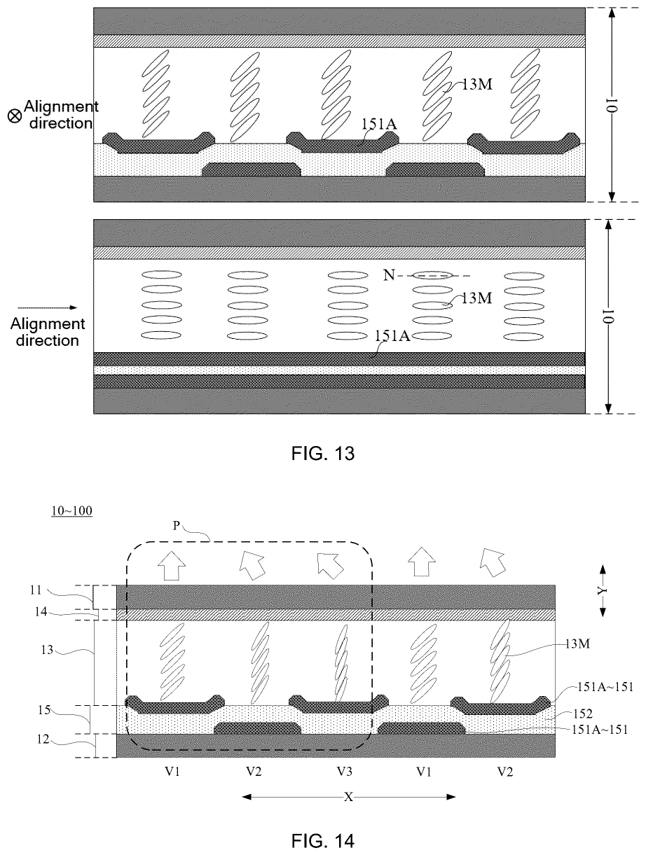

In some embodiments, as shown in FIG. 13, there are a plurality of light modulation units 10, and the plurality of light modulation units 10 are stacked in the thickness direction Y of the liquid crystal layer 13. The arrangement directions of the control electrodes 151A of two adjacent light modulation units 10 intersect.

For example, an angle formed by the arrangement directions of the control electrodes 151A of two adjacent light modulation units 10 may be 30°, 45°, 60°, 75° or 90°, etc.

In some examples, the light modulation unit 10 further includes an alignment film (e.g., a first alignment film and/or a second alignment film). In this case, the alignment film may be used to align the first liquid crystal molecules 13M of the two light modulation units 10, so that the alignment directions of the first liquid crystal molecules 13M of the two light modulation units 10 intersect.

It can be understood that the liquid crystal molecules have birefringence (also known as dichroism), and capable of modulating light of one polarization state, and the polarization angle of the light of the polarization state is related to the optical axis direction of the liquid crystal molecules; in the case where the arrangement directions of the control electrodes 151A of two adjacent light modulation units 10 intersect, the directions of the optical axes N of the first liquid crystal molecules 13M of the two adjacent light modulation units 10 are different, so that the two adjacent light modulation units 10 capable of modulating light of two polarization states, thereby improving the modulation effect and modulation efficiency of the light modulation module 100.

For example, in the case where the light modulation module 100 includes a plurality of light modulation units 10, two adjacent light modulation units 10 may be bonded by transparent adhesive material or connected by physical buckle, which is not limited here.

In some embodiments, as shown in FIG. 13, the number of the light modulation units 10 is two, and the arrangement directions of the control electrodes 151A of the two light modulation units 10 are particular to each other.

It can be understood that with the above arrangement, the two light modulation units 10 capable of modulating light of two polarization states with perpendicular polarization directions, so that the display image generated after modulation by the light modulation module 100 is closer to the display image before modulation, and the aberration that may be formed during the display process may be reduced.

In some examples, the light modulation module 100 may be used in application scenarios with high modulation specifications. In this case, the light modulation module 100 may use the human eye tracking technology to capture the iris of the person at the viewing angle or track the geometric features of the human eye to provide feedback on the peeping position. In this case, the light modulation module 100 may include a plurality of light modulation units 10. By controlling the driving voltage, the plurality of light modulation units 10 may adjust the light exit direction according to the fed-back peeping position, and compensate for any viewing angle as needed to improve the modulation effect.

Some embodiments of the present disclosure provide a driving method of a light modulation module 100. The light modulation module 100 is the light modulation module 100 described in any of the above embodiments. The driving method of the light modulation module 100 includes: as shown in FIG. 14, inputting control voltages to a plurality of control electrodes 151A, and inputting a common voltage to the common electrode layer 14, so as to drive the first liquid crystal molecules 13M to rotate from an initial state to a first stable state, so that the refractive index distribution of the light modulation unit 10 is periodically arranged in the first direction X entirely or locally.

Here, the refractive index distribution may be understood as, in a case where the light modulation unit 10 is divided into multiple parts in a certain way (for example, in the first direction X) when the light modulation unit 10 is in a certain state (for example, when the first liquid crystal molecules 13M rotate to the first stable state), the variation of the refractive index of each part with the position of the part. Therefore, the refractive index distribution of the light modulation unit 10 is associated with the state of the light modulation unit; that is, the light modulation unit 10 in different states may have different refractive index distributions. Here, the state of the light modulation unit 10 is different, which is understood that, for example, the method for applying the control voltages to the light modulation unit 10 is different.

In some embodiments, as shown in FIG. 14, in the case where the first liquid crystal molecules 13M rotate to the first stable state, the refractive index distributions of the various modulation apertures P of the light modulation unit 10 are the same. In this case, the refractive index distribution of the light modulation unit 10 may be periodically arranged in the first direction X with one modulation aperture P as a cycle. In this case, the dimension of the modulation aperture P in the first direction X may be the same.

In some other embodiments, in the case where the first liquid crystal molecules 13M rotate to the first stable state, the light modulation unit 10 includes a plurality of parts, the refractive index distribution of each modulation aperture P located in a single part is the same, and the refractive index distributions of the modulation apertures P located in different parts are different. In this case, the refractive index distribution of each part of the light modulation unit 10 may be arranged periodically in the first direction X with the corresponding modulation aperture P as a cycle; in this case, the dimension of the modulation aperture P located in each part may be the same or different; that is, the modulation period of each part of the light modulation unit 10 may be the same or different.

It will be understood that in the case where the refractive index distributions of the two modulation apertures P are the same, the two modulation apertures P modulate light in a same way; in the case where the refractive index distributions of the two modulation apertures P are different, the two modulation apertures P modulate light in different ways. In this case, in the case where the first liquid crystal molecule 13M rotate to the first stable state, and the refractive index distribution of the light modulation unit 10 is arranged periodically in the first direction X entirely, the light modulation unit 10 may be divided into a plurality of modulation apertures P entirely, and the refractive index distribution of each modulation aperture P is substantially the same. In this case, light passing through different modulation apertures P of the light modulation unit 10 may be modulated in a same modulation method.

In the case where the first liquid crystal molecule 13M rotate to the first stable state, and the refractive index distribution of the light modulation unit 10 is arranged periodically in the first direction X locally, a part (i.e., local) of the light modulation unit 10 may be divided into a plurality of modulation apertures P. In this case, the light passing through this part of the light modulation unit 10 may be modulated in a same modulation method. It will be noted that, in this case, the rest of the light modulation unit 10 may be provided with a plurality of modulation apertures P, or may be provided with no modulation aperture P; that is, the light passing through the rest of the light modulation unit 10 may be modulated in another manner, or may not be modulated, and in which case modulation of the light of the local picture may be achieved. In the case where the light passing through the rest of the light modulation unit 10 is not modulated, the rest of the light modulation unit 10 may be not powered on, or the voltage between the control electrode 151A and the common electrode layer 14 may be 0, or no first liquid crystal molecules 13M is provided, which is not limited here.

Here, the change that occurs to the light after being modulated by the above modulation method may be a change in the exit angle; for example, the light is deflected, the light converges, or the light diverges. Moreover, in some examples, in a case where the light converges or diverges, the brightness of the display image or light modulated by the light modulation unit 10 may vary.

The beneficial effects of the driving method of the light modulation module 100 are the same as the beneficial effects of the light modulation module 100 described in some of the above embodiments, and will not be described in detail here.

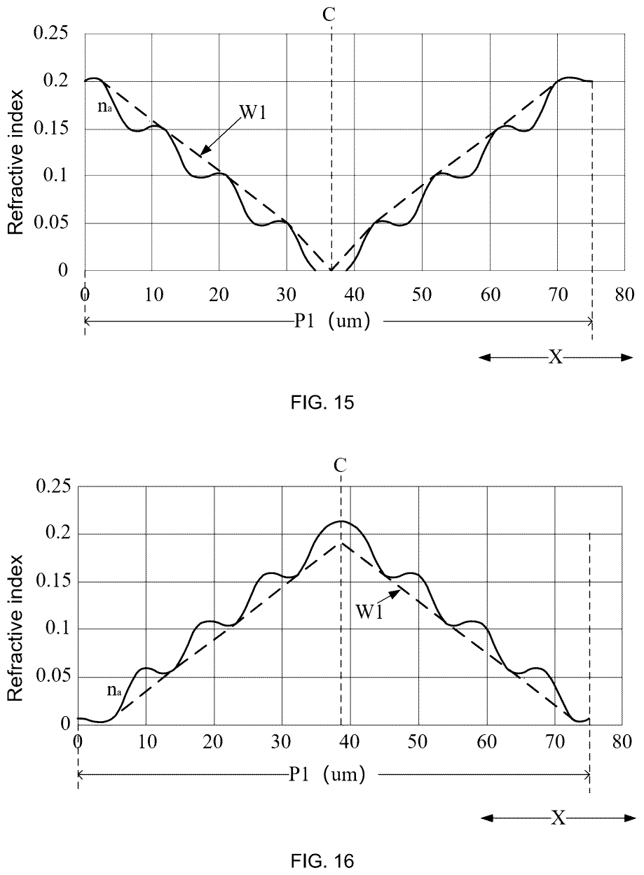

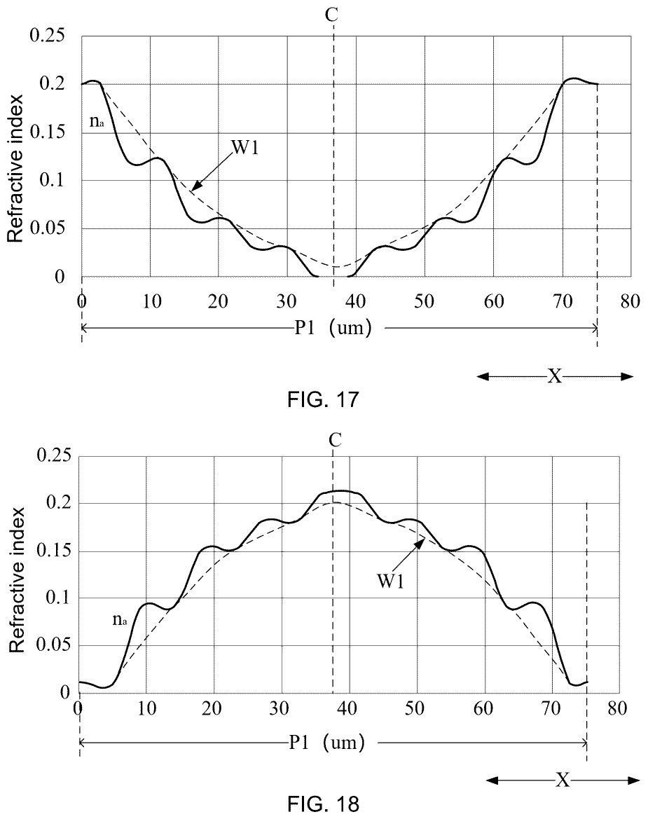

In some embodiments, as shown in FIGS. 1 and 4, and FIGS. 15 to 21, in the case where the first liquid crystal molecules 13M rotate to the first stable state, the light modulation unit 10 is divided into a plurality of first modulation portions P1 arranged in the first direction X. The plurality of first modulation portions P1 have a same refractive index distribution. The first modulation portion P1 includes at least two control electrodes 151A; a section of the first modulation portion P1 corresponding to a control electrode 151A has a first refractive index nₐ.

in the case where the light modulation unit 10 is divided into a plurality of first modulation portions P1 arranged in the first direction X, and the refractive index distributions of the plurality of first modulation portions P1 are the same, the refractive index distribution of the light modulation unit 10 is periodically arranged in the first direction with one first modulation portion P1 as a cycle; it can also be understood that the refractive index distribution of the light modulation unit 10 is arranged with the arrangement cycle of the first modulation portions P1 as a cycle.

It will be noted that, the method of making the refractive index distributions of the plurality of first modulation portions P1 the same is not limited here. For example, the thickness of the liquid crystal layer 13 corresponding to each first modulation portion P1 may be made equal, and the refractive index distributions of the plurality of first modulation portions P1 may be made the same by adjusting the driving voltage of each control electrode 151A. For another example, the thickness of the liquid crystal layer 13 corresponding to each first modulation portion P1 may be made unequal by providing protrusions or other manner, and the refractive index distributions of the plurality of first modulation portions P1 may be made the same by adjusting the driving voltage of each control electrode 151A.

It can be understood that, with the above-mentioned settings, the light passing through the light modulation unit 10 may include multiple light groups, and a light group corresponds to a first modulation portion P1; in this way, the light group may be modulated by the first modulation portion P1 corresponding thereto; moreover, in a case where the refractive index distributions of plurality of first modulation portions P1 are the same, the multiple light groups may be modulated in the same modulation method, so that the light may be modulated in light groups to achieve controllable modulation of the light.

The refractive index distribution of the first modulation portion P1 is exemplarily introduced below. Here, for understanding the refractive index distribution of the first modulation portion P1, reference may be made to the above description of the refractive index distribution of the light modulation unit 10.

As a possible implementation method, the refractive index distribution of the first modulation portion P1 in the first direction X may be obtained in the following way: define a boundary of the first modulation portion P1 as a reference point, use the distances between various sections of the first modulation portion P1 and the reference point in the first direction X as the horizontal coordinates, and use the first refractive index nₐ of various sections of the first modulation portion P1 as the vertical coordinates to draw a refractive index distribution diagram. Since the region corresponding to a control electrode has a closer first refractive index nₐ, in the refractive index distribution diagram, a control electrode may correspond to a curve segment. In this case, in order to more clearly show the variation of the first refractive index nₐ of the first modulation portion P1, the extreme points of all the curve segments may be connected to obtain a first change trend line W1 of the first refractive index nₐ, and the variation of the first refractive index nₐ may be obtained by the first change trend line W1.

In some embodiments, as shown in FIGS. 1, 4 and 15, in the case where the first liquid crystal molecules 13M rotate to the first stable state, the multiple first refractive indices nₐ of the first modulation portion P1 gradually decrease and then gradually increase in the first direction X and change in a broken line shape.

It will be understood that in the case where the multiple first refractive indices nₐ of the first modulation portion P1 gradually decrease and then gradually increase in the first direction X, and change in a broken line shape, the first change trend line W1 corresponding to the first modulation portion P1 is a V-shaped line opening upward.

It can be understood that, with the above arrangement, the first modulation portion P1 may have a minimum refractive index section at the turning point of the broken line, and the first refractive index nₐ of the minimum refractive index section is less than that of other sections of the first modulation portion P1. In the case where the multiple first refractive indices nₐ in the first modulation portion P1 gradually decrease and then gradually increase in the first direction X, the light rays on two sides, in the first direction X, of the minimum refractive index section are all deflected in a direction away from the minimum refractive index portion. In this way, the divergence of light rays may be achieved, so as to adjust the viewing angle and contrast of the display screen of the display apparatus, and adjust the light type of the light-emitting apparatus.

In some embodiments, as shown in FIGS. 1, 4 and 16, in the case where the first liquid crystal molecules 13M rotate to the first stable state, the multiple first refractive indices nₐ of the first modulation portion P1 gradually increase and then gradually decrease in the first direction X, and change in a broken line shape.

It will be understood that in the case where the multiple first refractive indices nₐ of the first modulation portion P1 gradually increase and then gradually decrease in the first direction X and change in a broken line shape, the first change trend line W1 corresponding to the first modulation portion P1 is a V-shaped line opening downward.

It can be understood that, with the above arrangement, the first modulation portion P1 may have a maximum refractive index section at the turning point of the broken line, and the first refractive index nₐ of the maximum refractive index portion is greater than that of other sections of the first modulation portion P1. In the case where the multiple first refractive indices nₐ of the first modulation portion P1 gradually increase and then gradually decrease in the first direction X, the light rays on two sides, in the first direction X, of the maximum refractive index section are deflected toward the direction proximate to the maximum refractive index section. In this way, light convergence may be achieved, so as to adjust the viewing angle and contrast of the display screen of the display apparatus, and adjust the light type of the light-emitting apparatus.

In some embodiments, as shown in FIGS. 1, 4 and 17, in the case where the first liquid crystal molecules 13M rotate to the first stable state, the multiple first refractive indices nₐ of the first modulation portion P1 gradually decrease and then gradually increase in the first direction X, and change in a parabolic shape.

It will be understood that in the case where the multiple first refractive indices nₐ of the first modulation portion P1 gradually decrease and then gradually increase in the first direction X, and change in a parabolic shape, the first change trend line W1 corresponding to the first modulation portion P1 is in a shape of a parabola opening upward (e.g., in a shape of a quadratic parabola).

It can be understood that, with the above configuration, the first modulation portion P1 may have a minimum refractive index section at the lowest point of the parabola, and the first refractive index nₐ of the minimum refractive index section is less than that of other sections of the first modulation portion P1. In this way, in the first direction X, the light rays on two sides of the minimum refractive index section are deflected in the direction away from the minimum refractive index section, so that the divergence of light rays may be achieved, so as to adjust the viewing angle and contrast of the display screen of the display apparatus, and adjust the light type of the light-emitting apparatus.

Moreover, the first liquid crystal molecules 13M may change the propagation distance of light to achieve different optical path differences, so as to achieve light deflection. In other words, by changing the curvature of the first change trend line W1, the focal distance may be modulated by utilizing a working principle similar to the contraction and relaxation of crystalline lens. Since the driving voltage is controllable, the focal distance of the light modulation unit 10 is adjustable. Compared with an ordinary lens, the light modulation unit 10 has the advantages of adjustable focal distance and flexibility, and may achieve specific light modulation specifications, and can be used in application scenarios such as three-dimensional display and virtual reality (VR) display.

In some embodiments, as shown in FIGS. 1, 4 and 18, in the case where the first liquid crystal molecules 13M rotate to the first stable state, the multiple first refractive indices nₐ of the first modulation portion P1 gradually increase and then gradually decrease in the first direction X, and change in a parabolic shape.

It will be understood that in the case where the multiple first refractive indices nₐ of the first modulation portion P1 gradually increase and then gradually decrease in the first direction X, and change in a parabolic shape, the first change trend line W1 corresponding to the first modulation portion P1 is in a shape of a parabola opening downward (e.g., a quadratic parabola).

It can be understood that, with the above arrangement, the first modulation portion P1 may have a maximum refractive index section at the highest point of the parabola, and the first refractive index nₐ of the maximum refractive index section is greater than that of other sections of the first modulation portion P1. In this way, in the first direction X, the light rays on two sides of the maximum refractive index section are deflected toward the direction proximate to the maximum refractive index section, so that the divergence of light rays may be achieved, so as to adjust the viewing angle and contrast of the display screen of the display apparatus, and adjust the light type of the light-emitting apparatus. Moreover, the focal distance of the light modulation unit 10 is adjustable. Compared with an ordinary lens, the light modulation unit 10 has the advantages of adjustable focal distance and flexibility, can achieve specific light modulation specifications, and can be used in application scenarios such as three-dimensional display and virtual reality (VR) display.

The following will describe the modulation principle of the light by the light modulation unit 10 in the case where the plurality of first refractive indices nₐ of the first modulation portion P1 change in a parabolic shape from the perspective of wave optics.

The initial light is represented as U(r). After being incident on the first modulation portion P1, the initial light U(r) is subjected to a light transfer function tlens(r) (which may be abbreviated as t(r)) to form an output light U′(r), which may satisfy: U′(r)=t(r)·U(r).

Here, the light transfer function may be expressed as t(r)=e^{-jϕ}(r), where ϕ(r)=k·n(r)·d(r); k is the wave number in free space, for example, k=2π/λ; d(r) is the propagation distance, and n(r)·d(r) represents the propagation light path.

In a case of ϕ(r)=k·r²/(2f), the first modulation portion P1 has a converging effect on light, where f is the focal distance.

The focal distance f may be expressed as f=(r₀\hat{ }2)/(2(n_{c}−n_{b})·d), i.e., f=(r₀\hat{ }2)/(2Δn(d_{c}·d_{b})). In this case, the light transfer function may also be expressed as

$$t ( r ) = {e}^{- j φ ( r} ) = exp ( - j \cdot k \cdot d \cdot \frac{{n}_{c} - {n}_{b}}{{r}_{0}^{2}} \cdot {r}^{2} \cdot exp ( - j \cdot k \cdot d \cdot {n}_{c} ) ,$$

n_{c} is the extraordinary refractive index of the first modulation portion P1 at the center, n_{b} is the extraordinary refractive index of the first modulation portion P1 at the edge; r is the position of the first modulation portion P1; r₀ is the dimension of the first modulation portion P1; d is the thickness; d_{b} is the edge thickness; do is the center thickness; j is an imaginary unit.

From the above analysis, it can be seen that a more direct way to change the focal distance of the first modulation portion P1 is to change the curvature of the first change trend line W1.

In some examples, the first change trend line W1 is a parabola. In the case where the viewing distance is D and the focal distance of the first modulation portion P1 is f, after modulation by the first modulation portion P1, the viewing angle of the output light may reach (1-D/f) times the viewing angle of the incident light. Here, the focal length may be positive or negative. In the case where the focal distance of the first modulation portion P1 is positive, the viewing angle becomes small; in the case where the focal distance of the first modulation portion P1 is negative, the viewing angle becomes large.

In some embodiments, as shown in FIGS. 1 and 4, and FIGS. 15 to 18, in the case where the multiple first refractive indices nₐ of the first modulation portion P1 gradually decrease in the first direction X and then gradually increase, the control electrode 151A corresponding to the smallest of the multiple first refractive indices nₐ is located at the center C of the first modulation portion P1. In the case where the multiple first refractive indices nₐ of the first modulation portion P1 gradually increase and then gradually decrease in the first direction X, the control electrode 151A corresponding to the greatest one of the multiple first refractive indices nₐ is located at the center C of the first modulation portion P1.

It will be understood that the control electrode 151A corresponding to the smallest one of the multiple first refractive indexes nₐ corresponds to the above-mentioned minimum refractive index section. The control electrode 151A corresponding to the largest one of the plurality of first refractive indexes nₐ corresponds to the maximum refractive index section.

Here, the control electrode 151A is located at the center C of the first modulation portion P1, which may be understood as the center C of the first modulation portion P1 being located on the center line of the control electrode 151A. It will be noted that, the description of “located at the center C of the first modulation portion P1” includes absolute located at the center C of the first modulation portion P1 and close to the center C of the first modulation portion P1, and an acceptable range of deviation of “close to the center C of the first modulation portion P1” may be, for example, that a difference between two equals is less than or equal to 5% of either of the two equals.

It can be understood that in the case where the control electrode 151A corresponding to the smallest one of the multiple first refractive indices nₐ is located at the center C of the first modulation portion P1, the light rays located on two sides of the minimum refractive index section are deflected in the direction away from the center C of the first modulation portion P1; in the case where the control electrode 151A corresponding to the largest one of the multiple first refractive indices nₐ is located at the center C of the first modulation portion P1, the light rays located on two sides of the maximum refractive index section are deflected in the direction proximate to the center C of the first modulation portion P1. In this way, the light rays passing through the first modulation portion P1 may converge toward the center or diverge to two sides with the center of the first modulation portion P1 as the center of symmetry, thereby realizing symmetrical modulation.

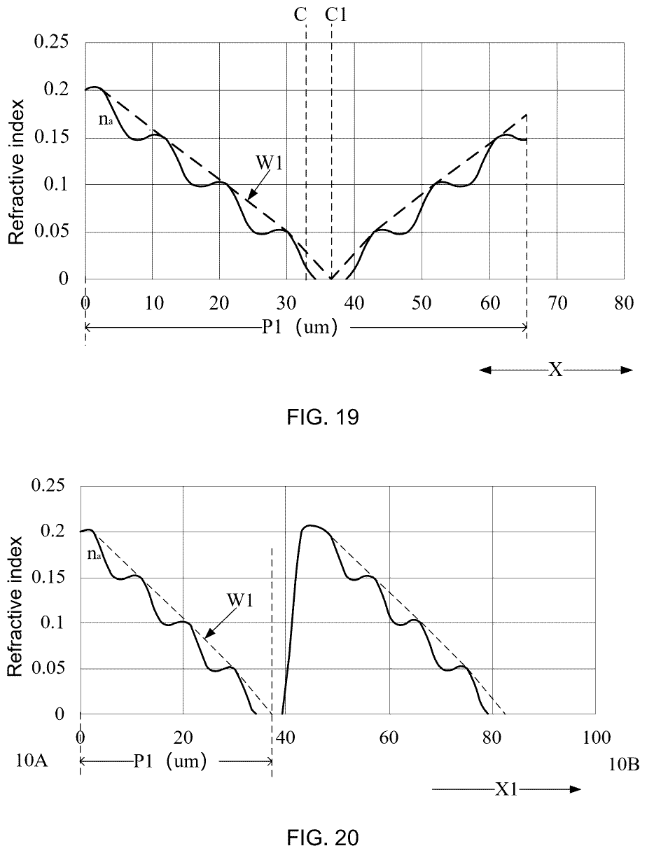

In some embodiments, as shown in FIG. 19, in the case where multiple first refractive indices nₐ of the first modulation portion P1 gradually decrease and then gradually increase in the first direction X, the center C1 of the control electrode corresponding to the smallest one of the multiple first refractive indices nₐ deviates from the center C of the first modulation portion P1. in the case where the multiple first refractive indices nₐ of the first modulation portion P1 gradually increase and then gradually decrease in the first direction X, the center C1 of the control electrode corresponding to the largest one of the multiple first refractive indices nₐ deviates from the center C of the first modulation portion P1.

It can be understood that in the case where the center C1 of the control electrode corresponding to the smallest one of the multiple first refractive indices nₐ deviates from the center C of the first modulation portion P1, the light rays located on two sides of the minimum refractive index section are deflected in the direction away from the minimum refractive index section, and the minimum refractive index section deviates from the center C of the first modulation portion P1; in the case where the center C1 of the control electrode corresponding to the largest one of the multiple first refractive indices nₐ deviates from the center C of the first modulation portion P1, the light rays located on two sides of the maximum refractive index section are deflected in the direction proximate to the minimum refractive index section, and the maximum refractive index section deviates from the center C of the first modulation portion P1. In this way, asymmetric modulation of light rays may be achieved, that is, in the process of achieving light convergence or divergence, light is deflected, which may be used in application scenarios such as privacy protection and viewing at a specific angle.

In some embodiments, as shown in FIGS. 20 to 22, in the case where the first liquid crystal molecules 13M are deflected to the first stable state, the multiple first refractive indices nₐ of the first modulation portion P1 gradually decrease and decrease linearly in the second direction X1; the second direction X1 is a direction from the first border 10A of the light modulation unit 10 to the second border 10B; the first border 10A and the second border 10B are arranged in the first direction X.

It will be understood that in the case where the multiple first refractive indices nₐ of the first modulation portion P1 gradually decrease and decrease linearly in the second direction X1, the first change trend line W1 corresponding to the first modulation portion P1 is an inclined straight line, and the refractive index of a part of the inclined straight line proximate to the second border 10B is less than the refractive index of a part of the inclined straight line proximate to the first border 10A.

It can be understood that, with the above-mentioned setting, the light passing through the first modulation portion P1 may be deflected in the direction proximate to the first border 10A. In this way, it may be equivalent to a prism to achieve directional deflection of the light, for example, deflection towards the direction away from the viewing angle, which may be used in application scenarios such as privacy protection, viewing at a specific angle, and dual-view display. Moreover, when applied to privacy protection, the light modulation unit 10 may be used to change the overall exit angle of the light without changing the relative position of the light emission, that is, only the viewing angle may be changed without damaging the display quality.

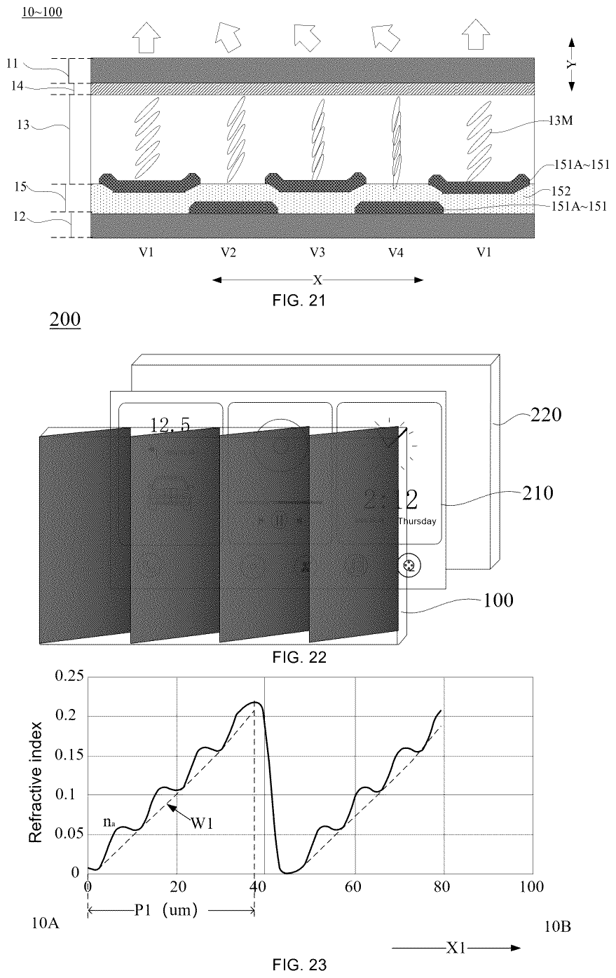

In some examples, as shown in FIG. 21, when the incident light and the light receiving surface are the same, the rotation angle of the first liquid crystal molecules 13M gradually increases in an order from V1 to V4, Δnd gradually decreases, and the path of the outgoing light gradually increases, so that the deflection angle of the light gradually increases. This may also be verified based on Fermat's principle, where light propagates from one point to another point, no matter how many times it undergoes refraction and reflection, the optical path is always an extreme value.

In some embodiments, as shown in FIGS. 1, 4 and 23, in the case where the first liquid crystal molecules 13M rotate to the first stable state, the multiple first refractive indices nₐ of the first modulation portion P1 gradually increase and increase linearly in the second direction X1; the second direction X1 is the direction from the first border 10A of the light modulation unit to the second border of the light modulation unit; the first border 10A and the second border 10B are arranged in the first direction X.

It will be understood that in the case where the multiple first refractive indices nₐ of the first modulation portion P1 gradually increase and increase linearly in the second direction X1, the first change trend line W1 corresponding to the first modulation portion P1 is an inclined straight line, and the refractive index of a part of the inclined straight line proximate to the second border 10B is greater than the refractive index of a part of the inclined straight line proximate to the first border 10A.

It can be understood that, with the above-mentioned setting, the light passing through the first modulation portion P1 may be deflected in the direction proximate to the second border. In this way, it can be equivalent to a prism to achieve a 0 to 90° directional deflection of the light, for example, deflection towards the direction away from the viewing angle, which may be used in application scenarios such as privacy protection, viewing at a specific angle, and dual-view display. Moreover, when applied to privacy protection, the light modulation unit 10 may be used to change the overall exit angle of the light without changing the relative position of the light emission, that is, only the viewing angle may be changed without damaging the display quality.

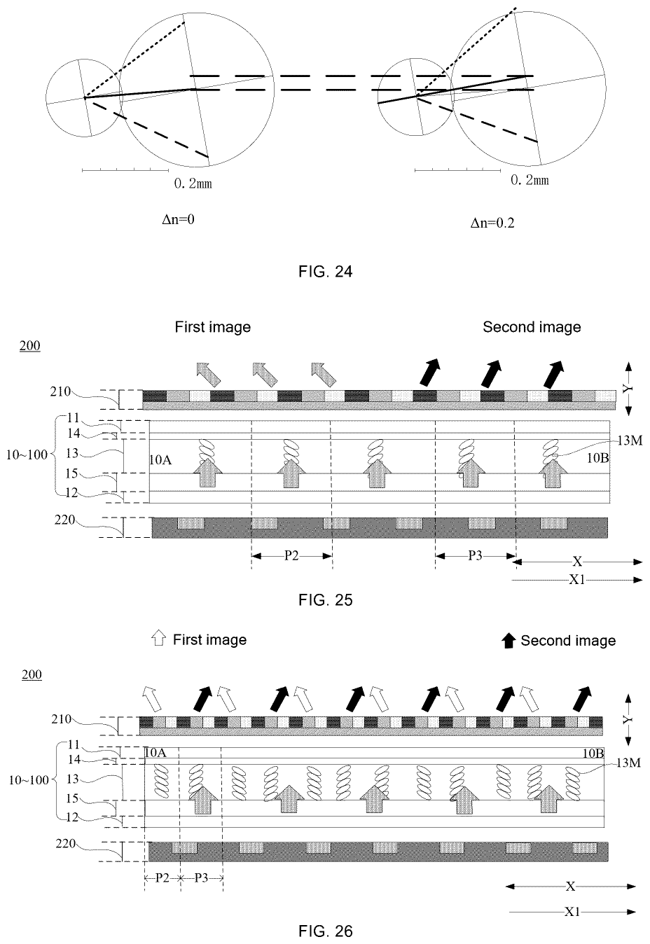

In some examples, in the case where the first liquid crystal molecules 13M rotate to the first stable state, the multiple first refractive indices nₐ of the first modulation portion P1 gradually decrease and decrease linearly in the second direction X1, and the modulation effect of the light is simulated. The results are shown in FIG. 24. As shown in FIG. 24, by regulating the driving voltage to adjust the exit angle of the light, the output light may be made parallel in direction, that is, only the viewing angle is changed without damaging the display quality. After the three equally spaced viewpoints in FIG. 24 pass through the first modulation unit P1, the spacing between the imaging points remains unchanged, but the overall position shifts, which indicates that the light adjustment layer has changed the overall exit angle of the light, but has not changed the relative position of the light.

In some embodiments, as shown in FIGS. 25 and 26, the light modulation module 100 may be applied to a display apparatus 200 and used in conjunction with a display substrate 210 (e.g., a 2D display substrate). The display screen of the display substrate 210 may achieve a dual-view display effect after being modulated by the light modulation module 100. For example, it can be applied to a vehicle-mounted display apparatus. The dual-view display may clearly and accurately divide the viewing areas of the driver and the passenger, thereby optimizing the display effect. Thus, both the driver and the passenger obtain complete visual information, enjoy a good visual experience and high comfort, and watch without interfering with each other, thereby achieving safe driving and ensuring the driver's concentration and attention during driving.

The following is an exemplary introduction to a method for implementing the dual-view display.

In some embodiments, as shown in FIG. 25, in the case where the first liquid crystal molecules 13M rotate to the first stable state, the light modulation unit 10 is divided into a plurality of second modulation portions P2 and a plurality of third modulation portions P3 arranged in the first direction X. The plurality of second modulation portions P2 have the same refractive index distribution; the second modulation portion P2 includes at least two control electrodes 151A; a section of the second modulation portion P2 corresponding to one control electrode 151A has a second refractive index; the plurality of second refractive indices of the second modulation portion P2 decrease linearly in the second direction X1. The plurality of third modulation portions P3 have the same refractive index distribution; the third modulation portion P3 includes at least two control electrodes 151A; a section of the third modulation portion P3 corresponding to one control electrode 151A has a third refractive index; the plurality of third refractive indices of the third modulation portion P3 increase linearly in the second direction X1. The second direction X1 is a direction from the first border 10A of the light modulation unit 10 to the second border 10B of the light modulation unit 10; the first border 10A and the second border 10B are arranged in the first direction X; the plurality of second modulation portions P2 are located at a side, proximate to the first border 10A, of the light modulation unit 10 in the first direction X, and the plurality of third modulation portions P3 are located at a side, proximate to the second border 10B, of the light modulation unit 10 in the first direction X.

It can be understood that in a case where the plurality of second refractive indices of the second modulation portion P2 decrease linearly in the second direction X1, the light passing through the second modulation portion P2 may be deflected in the direction proximate to the first border 10A to display a first image; in a case where the plurality of third refractive indices of the third modulation portion P3 increase linearly in the second direction X1, the light passing through the second modulation portion P2 may be deflected in the direction proximate to the second border 10B to display a second image, thereby achieving a dual-view display effect. Here, regarding the reasons why the light passing through the second modulation portions P2 may be deflected toward the direction proximate to the first border 10A, and/or the light passing through the third modulation portion P3 may be deflected toward the direction proximate to the second border 101B, reference will be made to the above description of the case where plurality of first refractive indices nₐ of the first modulation portion P1 decrease or increase linearly, which will not be repeated here.

Moreover, the plurality of second modulation portions P2 are located at a side, proximate to the first border 10A, of the light modulation unit 10 in the first direction X, and the plurality of third modulation portions P3 are located at a side, proximate to the second border 10B, of the light modulation unit 10 in the first direction X, so that the light passing through the light modulation unit 10 may respectively be deflected from the first border 10A to a closer border and from the second border 10B to a closer border, and the light passing through the second modulation portions P2 and the light passing through the third modulation portions P3 have less mutual influence, which may improve the display effect.

In some embodiments, as shown in FIG. 26, in the case where the first liquid crystal molecules 13M rotate to the first stable state, the light modulation unit 10 is divided into a plurality of second modulation portions P2 and a plurality of third modulation portions P3 arranged in the first direction X. The plurality of second modulation portions P2 have the same refractive index distribution; the second modulation portions P2 includes at least two control electrodes 151A; a section of the second modulation portion P2 corresponding to one control electrode 151A has a second refractive index; the plurality of second refractive indices of the second modulation portion P2 decrease linearly in the second direction X1. The plurality of third modulation portions P3 have the same refractive index distribution; the third modulation portion P3 includes at least two control electrodes 151A; a section of the third modulation portion P3 corresponding to one control electrode 151A has a third refractive index; the plurality of third refractive indices of the third modulation portion P3 increase linearly in the second direction X1. The second direction X1 is the direction from the first border 10A of the light modulation unit 10 to the second border 10B of the light modulation unit 10; the first border 10A and the second border 10B are arranged in the first direction X; the plurality of second modulation portions P2 and the plurality of third modulation portions P3 are alternately arranged in the first direction X.

It can be understood that according to the above content, the light passing through the second modulation portion P2 may be deflected toward the direction proximate to the first border 10A to display a first image; the light passing through the third modulation portion P3 may be deflected toward the direction proximate to the second border 10B to display a second image, thereby achieving a dual-view display effect. Moreover, in the case where the plurality of second modulation portions P2 and the plurality of third modulation portions P3 are alternately arranged in the first direction X, the plurality of sub-images of the first image and the plurality of sub-images of the second image are alternately arranged, and the viewing angles of the first image and the second image are large.

In some examples, in the case where the plurality of second modulation portions P2 and the plurality of third modulation portions P3 are alternately arranged in the first direction X, in the display substrate 210 used in conjunction with the light modulation module 100, two pixels are a display unit to achieve effective separation of dual-view images.

In some examples, the light modulation module 100 is applied to a vehicle-mounted display apparatus, and the screen one of the first image and the second image that is projected onto the driver is used to display navigation and safe driving information. In this case, the deflection angle of the light corresponding to the image projected onto the driver may be increased, so that the driver can see the projected image while keeping his sight on the dashboard and reducing unnecessary turning of the head.

In some embodiments, as shown in FIGS. 1, 4, 19, 25 and 26, a selected modulation portion is any one of the first modulation portion P1, the second modulation portion P2 and the third modulation portion P3, and a selected refractive index is one of the first refractive index nₐ, the second refractive index and the third refractive index corresponding to the selected modulation portion; in the case where the first liquid crystal molecules 13M rotate to the first steady state, a deflection angle β is formed between the output light corresponding to the larger selected refractive index of the plurality of selected refractive indices of a selected modulation portion and the output light corresponding to the smaller selected refractive index of the plurality of selected refractive indices of the selected modulation portion; the deflection angle β satisfies the formula:

$$β = arcsin ( \frac{{n}_{0} * ( {n}_{0} - {n}_{1} ) d}{{n}_{1} \sqrt{{( {n}_{0} - {n}_{1} )}^{2} * {d}^{2} + {r}_{1}^{2}}} )$$

where n₀ is the extraordinary refractive index of the first liquid crystal molecules 13M corresponding to the smaller selected refractive index, n₁ is the ordinary refractive index of the first liquid crystal molecules, d is the thickness of the liquid crystal layer 13, and r₁ is a width of the selected modulation portion in the first direction.

It will be understood that through the formula of the above-mentioned deflection angle β, the corresponding relationship between the material property of the light modulation module 100 (e.g., the material property of the first liquid crystal molecules 13M) the structural properties (e.g., the thickness of the liquid crystal layer 13, the size of the selected modulation portion), and the deflection angle may be obtained. In this way, by adjusting the above-mentioned material property and structural properties, the light modulation module 100 may achieve the set deflection angle when modulating light, thereby achieving the purpose of controllable modulation.

It can be seen from the above formula of the deflection angle β that, in the case where the extraordinary refractive index n₀ corresponding to the smaller selected refractive index is larger, the deflection angle β is larger, and the extraordinary refractive index n₀ is associated with the driving voltage. In this way, by controlling the driving voltage, i.e., controlling the voltage of the common electrode layer 14 and/or the voltage of the control electrode 151, the deflection angle β may be set to meet the set requirements.

In some examples, the output light corresponding to the larger selected refractive index is the light emitted in the normal direction of the first substrate 11.

In some examples, the control electrode 151A corresponding to the larger selected refractive index is disposed at a border of the selected modulation portion; the control electrode 151A corresponding to the smaller selected refractive index is disposed at the other border of the selected modulation portion.

It will be noted that in the selected modulation section, the driving voltage of the other control electrodes 151A, except the control electrode 151A corresponding to the smaller selected refractive index, is not limited here, as long as it is smaller than the driving voltage of the control electrode 151A corresponding to the smaller selected refractive index.

In some examples, in the selected modulation portion, the driving voltage of the control electrode 151A changes gradually in the first direction X. In this case, the electric field of the selected modulation portion is relatively continuous.

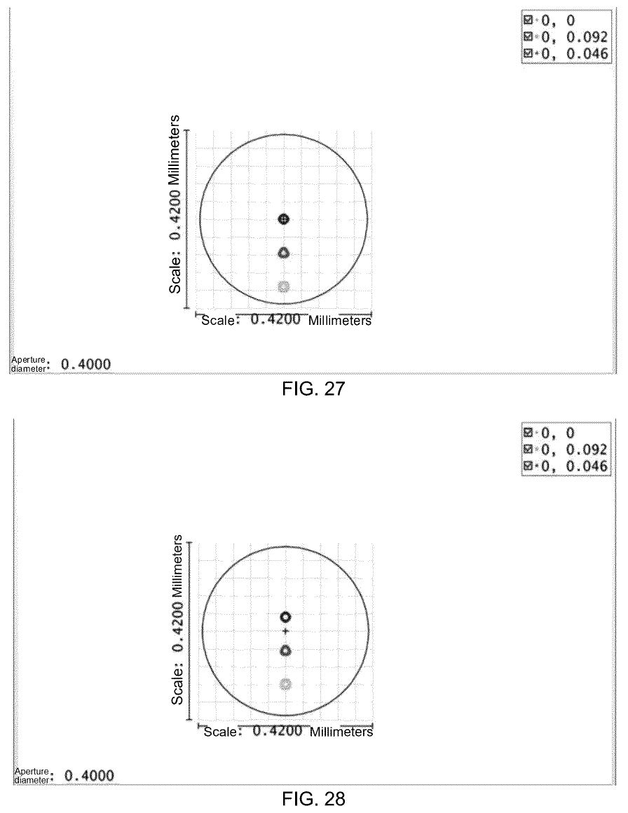

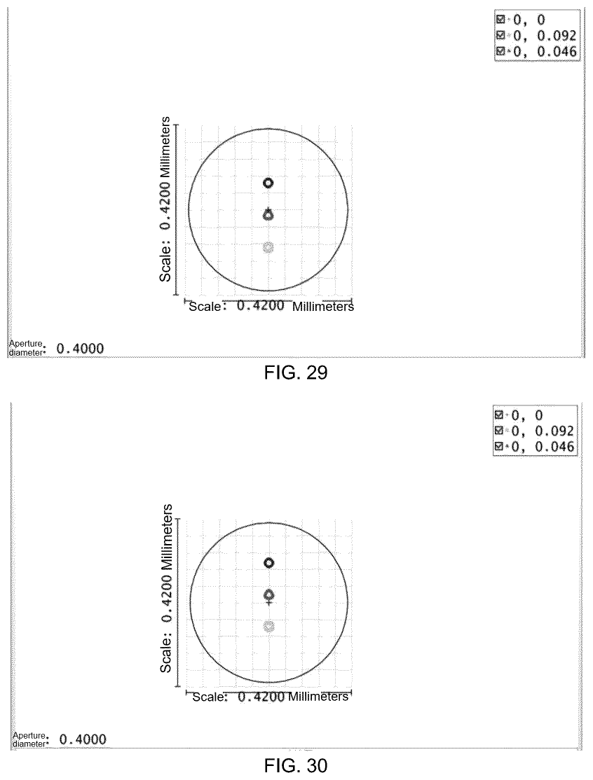

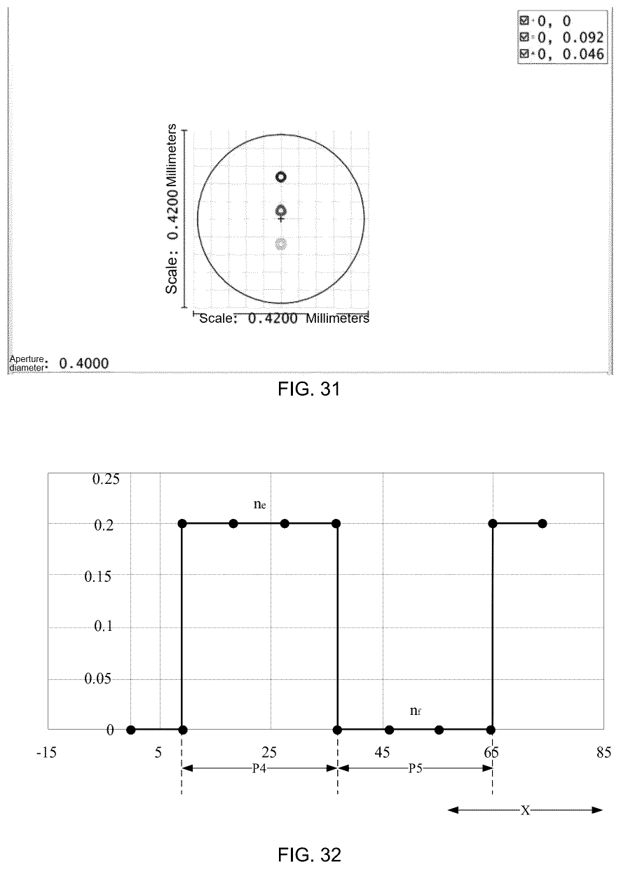

In some examples, considering an 8.4-inch vehicle display apparatus with a resolution of 1280×900 and equipped with a light modulation module as an example, the rotation angle that can be achieved by a single light modulation unit 10 is calculated and simulated in the case where the difference Δn between the extraordinary refractive index n₀ and the ordinary refractive index n₁ of the first liquid crystal molecules 13M is different (Δn=0, 0.2, 0.4, 0.6, 0.8). In the light modulation module, there is one light modulation unit, and the width r₁ of the selected modulation portion (corresponding to 15 control electrodes) in the first direction is 136.5 μm. The simulation results (light trace diagrams) in the case of Δn=0, 0.2, 0.4, 0.6, and 0.8 are shown in FIGS. 27 to 31, respectively. In order to describe the simulation results more clearly, the following Table 2 is used to show the differences in the simulation results in the case of Δn=0, 0.2, 0.4, 0.6, and 0.8.

TABLE 2

| | | Δn = 0 | Δn = 0.2 | Δn = 0.4 | Δn = 0.6 | Δn = 0.8 |
|---|---|---|---|---|---|---|
| Distance | Viewpoint 1 | −1.04 | −1.03 | −1.03 | −1.03 | −1.03 |
| from origin | (on-axis viewpoint) | | | | | |
| | Viewpoint 2 | 46.2 | 46.4 | 46.5 | 46.6 | 46.76 |
| | (paraxial viewpoint) | | | | | |
| | Viewpoint 3 | 93.5 | 93.85 | 94.12 | 94.12 | 94.54 |
| | (edge viewpoint) | | | | | |

| | | | | | |
|---|---|---|---|---|---|
| Simulation angle | 0° | 5° | 12° | 20° | 30° |
| Calculated angle | 0° | 3° | 10° | 17° | 28° |

It can be seen from the above simulation results that the deflection angle calculated by the deflection angle β formula is close to the deflection angle obtained by simulation. Moreover, based on the above-mentioned vehicle-mounted display apparatus, in a case of r₁=136.5 μm and Δn=0.2, a deflection angle of 5° may be achieved. If a deflection angle of 45° is desired, the difference Δn between the extraordinary refractive index n₀ and the ordinary refractive index n₁ of the first liquid crystal molecules may be increased to 1.05; alternatively, the width r₁ of the selected modulation portion in the first direction may be reduced to 13.65 μm (approximately corresponding to 2 control electrodes), and the driving voltage may be adjusted accordingly, so that the vehicle-mounted display apparatus meets the application requirements of privacy protection.

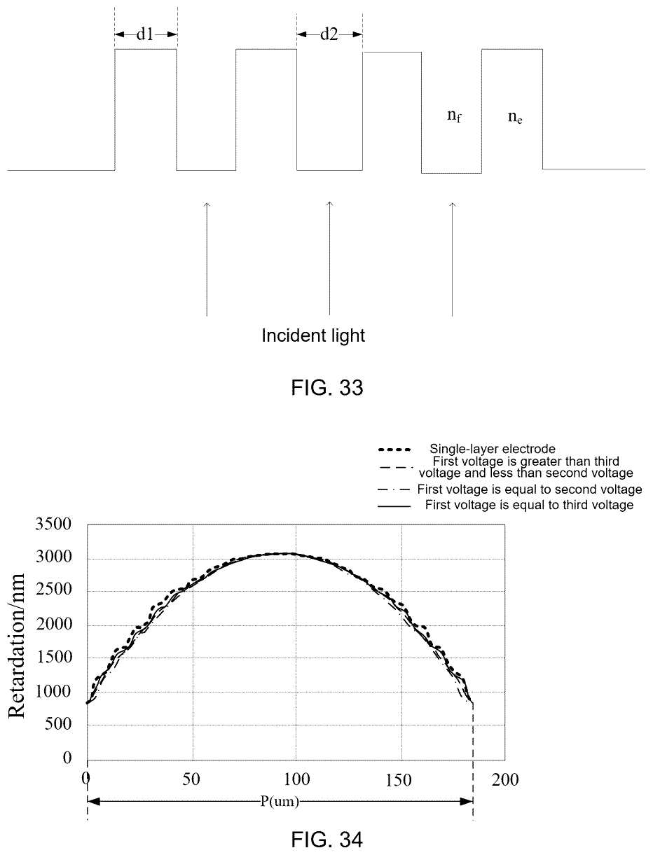

In some embodiments, as shown in FIGS. 1, 32 and 33, in the case where the first liquid crystal molecules 13M rotate to the first stable state, the light modulation unit 10 is divided into a plurality of fourth modulation portions P4 and a plurality of fifth modulation portions P5 alternately arranged in the first direction X. The fourth modulation portion P4 has a fourth refractive index ne, and the fifth modulation portion P5 has a fifth refractive index nₜ; the fourth refractive index ne is greater than the fifth refractive index nₜ. The difference between the phase retardation of two adjacent fourth modulation portions P4 is 2π.

It can be understood that, with the above configuration, based on the grating diffraction principle, the light modulation unit 10 may modulate the exit angle and brightness of the light, and the modulation period is (d1+d2). Specifically, the diffraction order may be changed by changing the period of the refractive index distribution to achieve different light diffraction angles; the proportion of the fifth refractive index n_{f} in the refractive index distribution of the light modulation unit 10 (which may also be understood as the duty cycle of the rectangular distribution of the refractive index), and the values of the fourth refractive index ne and the fifth refractive index n_{f} will affect the diffraction efficiency. Based on this, the above factors may be used to adjust the brightness of the display images.

In some examples, according to the grating diffraction principle, in a case where the zero-order diffraction peak intensity is 0, the first-order diffraction peak reaches a maximum, and at this case the display effect of the light modulation layer is optimal.

In the related art, an optical element that capable of performing spatial periodic modulation on the amplitude or phase of incident light, or simultaneously perform spatial periodic modulation on both amplitude and phase is called a diffraction grating. The grating has a function of spectrometer. After polychromatic light of different wavelengths passes through the grating, each wavelength forms its own set of fringes, and they are staggered at a certain distance from each other, thereby for distinguishing the spectral composition of lighting broadcasts.

The transmittance matrix of the grating may be expressed by T:

$$T = cos ( \frac{Γ}{2} ) [ \begin{matrix}1 & 0 \\ 0 & 1\end{matrix} ] - \frac{i}{2} sin ( \frac{Γ}{2} ) {e}^{i 2 α} [ \begin{matrix}1 & i \\ i & - 1\end{matrix} ] - \frac{i}{2} sin ( \frac{Γ}{2} ) {e}^{- i 2 α} [ \begin{matrix}1 & - i \\ - i & - 1\end{matrix} ]$$

$$Γ = \frac{2 πΔ nd}{λ}$$

where Γ is the phase difference between o-light and e-light of the liquid crystal layer, i.e., the birefringence phase retardation.

The diffracted light beam after passing the grating has three diffraction orders: 0th order and ±1st order, where the 0th order keeps the original incident direction and polarization state; the second term of e\hat{ }i2α and the third term of e\hat{ }(−i2α) represent additional geometric phases, and these two geometric phases have opposite directions.

$${E}_{in 1} = [ \begin{matrix}1 \\ i\end{matrix} ] \qquad {E}_{in 2} = [ \begin{matrix}1 \\ - i\end{matrix} ]$$

$${E}_{out} = T \times {E}_{in}$$

In the case where the incident light is left-handed light Eᵢₙ₁ (or right-handed light Eᵢₙ₂), there are only two orders of diffracted light: 0th order and −1st order (or +1st order); if Γ=π, and the liquid crystal layer meets the half-wave condition, the 0th order diffraction disappears, and only the −1 st order diffraction, i.e. right-handed circularly polarized light (or +1 st order left-handed circularly polarized light), exists; the ±1st order diffracted light has a geometric phase, the size of which is e\hat{ }i2α, causing the output light to be deflected from the incident direction.

$${φ}_{\pm } = arcsin ( \pm \frac{λ}{Λ} )$$

According to the Fraunhofer formula, when the incident light is incident vertically, the deflection angle φ of the ±1st order diffraction light may obtain a large diffraction angle as long as the grating period is small enough.

Grating diffraction efficiency η, Dₘ is the coefficient of the vector Fourier transform of the transmitted light field.

$${D}_{m} = \frac{1}{Λ} {\int }_{0}^{Λ} T ( x ) {E}_{in} {e}^{- \frac{i 2 π x}{Λ}} dx$$

$$η = \frac{{\vert {D}_{m} \vert}^{2}}{{\vert {E}_{in} \vert}^{2}}$$

The diffraction efficiencies of different orders are:

$${η}_{0} = {cos}^{2} ( \frac{Γ}{2} )$$

$${η}_{+ 1} = \frac{1 - {S}_{3}}{2} {sin}^{2} ( \frac{Γ}{2} )$$

$${η}_{- 1} = \frac{1 + {S}_{3}}{2} {sin}^{2} ( \frac{Γ}{2} )$$

$${η}_{m} = 0 , ( m \neq 0 , \pm 1 )$$

where S₃ is one of the Stokes vectors, which is used to describe the state of circular polarization, and for the left-hand circular polarization, S₃=−1.

In some examples, the phase a of the grating diffracted light may be expressed as:

$$α = \frac{π}{λ} d sin θ ;$$

the single slit diffraction factor may be expressed as:

$${( \frac{sin α}{α} )}^{2} ;$$

the width of the grating and the width of a single period will affect the amplitude and phase of the output light, so that the duty cycle will affect the diffraction order.

In some embodiments, as shown in FIG. 1, the number of control electrode layers 151 is two. Among the two control electrode layers 151, control electrodes 151A of a control electrode layer 151 farther from the liquid crystal layer 13 include a third electrode 151D, and a control electrode layer 151 closer to the liquid crystal layer 13 includes two fourth electrodes 151E adjacent to the third electrode 151D. In the case where the first liquid crystal molecules 13M rotate to the first stable state, the control voltage applied to the third electrode 151D is a first voltage, and the voltages applied to the two fourth electrodes 151E are a second voltage and a third voltage respectively, and the second voltage is greater than the third voltage. The first voltage is greater than the third voltage and less than the second voltage.

It will be noted that the terms of “third” and “fourth” in the third electrode 151D and the fourth electrode 151E are relative concepts and are only used for descriptive purposes to make the relative position relationship of the three control electrodes 151A arranged in the two control electrode layers 151 clearer. In actual applications, the third electrode 151D and the two fourth electrodes 151E may be any three of the multiple control electrodes 151A that are adjacent to each other and located in adjacent control electrode layers 151. Moreover, depending on the position of a control electrode 151A described, a certain control electrode 151A may be either the third electrode 151D or the fourth electrode 151E.

It can be understood that in the case where the first liquid crystal molecules 13M rotate to the first stable state (i.e., the light modulation unit 10 is in the light modulation state), the vertical electric field between the common electrode layer 14 and the control electrode 151A plays a major role. In the case where the first voltage is greater than the third voltage and less than the second voltage, the voltages corresponding to the third electrode 151D and the two fourth electrodes 151E adjacent to the third electrode 151D change sequentially in the first direction. In this way, the electric field of the light modulator unit 10 may be more continuous, the rotation of the first liquid crystal molecules 13M may be more continuous, and the obtained phase distribution curve may be more continuous and smooth, so that the modulation effect of the light modulator unit 10 on light may be improved.

In some embodiments, as shown in FIG. 1, the number of control electrode layers 151 is two. Among the two control electrode layers 151, control electrodes 151A of a control electrode layer 151 farther from the liquid crystal layer 13 includes a third electrode 151D, and a control electrode layer 151 closer to the liquid crystal layer 13 includes two fourth electrodes 151E adjacent to the third electrode 151D. In the case where the first liquid crystal molecules 13M rotate to the first stable state, a control voltage applied to the third electrode 151D is a first voltage, and voltages applied to the two fourth electrodes 151E are a second voltage and a third voltage respectively, and the second voltage is greater than the third voltage. The first voltage is equal to the second voltage.

It can be understood that in the case where the first voltage is equal to the second voltage, the third electrode 151D and the fourth electrode 151E corresponding to the first voltage may input the same voltage, so that the signal input efficiency may be improved.

In some embodiments, as shown in FIG. 1, the number of control electrode layers 151 is two. Among the two control electrode layers 151, control electrode 151A of a control electrode layer 151 farther from the liquid crystal layer 13 includes a third electrode 151D, and a control electrode layer 151 closer to the liquid crystal layer 13 includes two fourth electrodes 151E adjacent to the third electrode 151D. In the case where the first liquid crystal molecules 13M rotate to the first stable state, a control voltage applied to the third electrode 151D is a first voltage, and voltages applied to the two fourth electrodes 151E are a second voltage and a third voltage respectively, and the second voltage is greater than the third voltage. The first voltage is equal to the third voltage.

It can be understood that in the case where the first voltage is equal to the third voltage, the third electrode 151D and the fourth electrode 151E corresponding to the third voltage may input the same voltage, so that the signal input efficiency may be improved. Moreover, in the case where the first voltage is equal to the third voltage, compared with the situation where the first voltage is equal to the second voltage and the situation where the first voltage is between the second voltage and the third voltage, the rotation angle of the first liquid crystal molecules 13M corresponding to the first voltage may be reduced, so that the power consumption of the light modulation unit 10 is low.

In some examples in which the light modulation unit includes two control electrode layers, the phase distribution curves, in the case where the first voltage is the above three cases, are compared to verify the driving effect, and the comparison results are shown in FIG. 34. Moreover, the figure also shows the phase distribution curve corresponding to the single-layer electrode and the reference curve. The reference curve is a smooth curve close to the curve corresponding to “the first voltage is greater than the third voltage and less than the second voltage”, which is obscured in the figure and is therefore not marked. Here, for the description of the single-layer electrode and the reference curve, reference may be made to the above content and will not be repeated here.

It can be seen from FIG. 34 that, in the case where the first voltage is greater than the third voltage and less than the second voltage, the phase distribution curve is more continuous and smoother and closer to the reference curve; in the case where the first voltage is equal to the second voltage, the corresponding phase retardation is slightly lower than that of the reference curve, which is because the rotation angle of the first liquid crystal molecules 13M corresponding to the first voltage is large; in the case where the first voltage is equal to the third voltage, the corresponding phase retardation is slightly higher than that of the reference curve, which is because the rotation angle of the first liquid crystal molecules 13M corresponding to the first voltage is small.

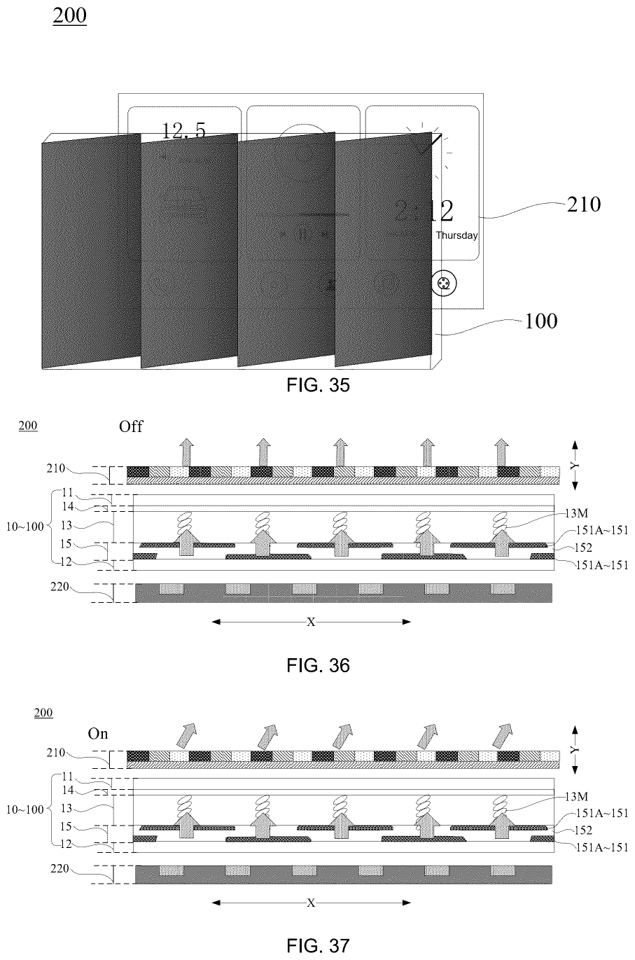

Some embodiments of the present disclosure provide a display apparatus 200. As shown in FIGS. 35 to 37, the display apparatus 200 includes a display substrate 210 and the light modulation module 100 as described in any of the above embodiments. The light modulation module 100 is connected to the display substrate 210.

For example, the light modulation module 100 and the display substrate 210 may be bonded by a transparent adhesive material or connected by physical buckle, which is not limited here.

It will be understood that, in the case where the light modulation module 100 is connected to the display substrate 210, the light modulation module 100 may modulate the light emitted by the display substrate 210, for example, causing the emitted light is deflected and/or causing the light to converge or diverge. Here, there is no limitation on the matching method between the control electrodes 151A and the pixels of the display substrate 210. For example, a control electrode 151A may be matched with a column of pixels or multiple columns of pixels; that is, the control electrodes 151A of the light modulation module 100 may be matched with the pixels of the display substrate 210 according to actual needs.

The above-mentioned display device 200 may be any product or component with display function, such as OLED panel, OLED TV, micro LED panel, micro LED TV, mini LED panel, mini LED TV, monitor, mobile phone, navigator, etc. The display apparatus 200 may be any display apparatus 200 that displays text or images whether in motion (e.g., a video) or stationary (e.g., a still image). More specifically, it is expected that the display apparatus 200 in the embodiments may be implemented in or associated with a plurality of electronic devices. The plurality of electronic devices may include (but is not limit to), for example, mobile telephones, wireless devices, personal data assistants (PDAs), hand-held or portable computers, GPS receivers/navigators, cameras, MP4 video players, video cameras, game consoles, watches, clocks, calculators, TV monitors, flat panel displays, computer monitors, car displays (e.g., odometer displays), navigators, cockpit controllers and/or displays, camera view displays (e.g., rear view camera displays in vehicles), electronic photos, electronic billboards or indicators, projectors, building structures, packagings and aesthetic structures (e.g., a display for an image of a piece of jewelry).

Beneficial effects of the display apparatus 200 are the same as those of the display substrate 100, which will not be repeated herein.

In some embodiments, as shown in FIG. 35, the display substrate 210 is any one of an organic light-emitting diode (OLED) display substrate, a light-emitting diode (LED) display substrate, a micro LED display substrate, and a mini LED display substrate; the light modulation module 100 is disposed on the light exit side of the display substrate 210.

It can be understood that in the case where the light modulation module 100 is arranged on the light exit side of the display substrate 210, the light modulation module 100 may modulate the light emitted by the display substrate 210, for example, causing the emitted light is deflected, and/or causing the light to converge or diverge, so as to achieve modulation effects such as privacy protection and dual-view display.

In some embodiments, the display substrate may be a liquid crystal display (LCD) display substrate 210. The display apparatus 200 further includes a backlight module 220. As shown in FIG. 22, the light modulation module 100 is disposed on a side of the display substrate 210 away from the backlight module 220. Alternatively, as shown in FIGS. 36 and 37, the light modulation module 100 is disposed between the display substrate 210 and the backlight module 220.

It can be understood that in the case where the light modulation module 100 is arranged between the display substrate 210 and the backlight module 220, the light modulation module 100 may modulate the light emitted by the backlight module 220 to change the type of the light emitted by the backlight module 220. Moreover, when the type of the light emitted by the backlight module 220 changes, the type of the incident light of the LCD display substrate 210 also changes, so that the modulation of the display screen of the LCD display substrate 210 may be achieved. The above-mentioned changes in light include but are not limited to changes in viewing angle, contrast or brightness.

For example, the backlight module 220 may be a direct-lit backlight module.

In some examples, as shown in FIGS. 36 and 37, the light modulation module 100 is disposed between the display substrate 210 and the backlight module 220, and the backlight module 220 is a high-collimation backlight module.

It will be understood that the degree of collimation of the backlight emitted by the backlight module 220 will affect the display brightness, uniformity and contrast of the display apparatus 200. By setting the backlight module 220 as a high-collimation backlight module, the contrast of the display image may be improved. Moreover, in this case, if the light modulation module 100 is turned off, the viewing angle is small. Therefore, the light modulation module 100 may be adjusted to be in a modulation state to increase the exit angle of light, thereby increasing the viewing angle of the display image to achieve the purpose of bright and wide viewing angle. Thus, the display apparatus 200 may be used in application scenarios such as wide viewing angle display.

In some examples, as shown in FIG. 22, the light modulation module 100 is disposed on a side of the display substrate 210 away from the backlight module 220. In this case, the light modulation module 100 may be configured to modulate the exit angle of the light to achieve the purpose of lateral shift of the viewing angle, so as to achieve the effect of display in a specific direction, which may be applied to application scenarios such as privacy protection and viewing at a specific angle.

In some embodiments, as shown in FIGS. 25, 26, and 35, the display apparatus 200 is a dual-view display apparatus or a privacy protection display apparatus.

Here, regarding the methods of realizing dual-view display and privacy protection display, reference will be made to the aforementioned content, which will not be repeated here.

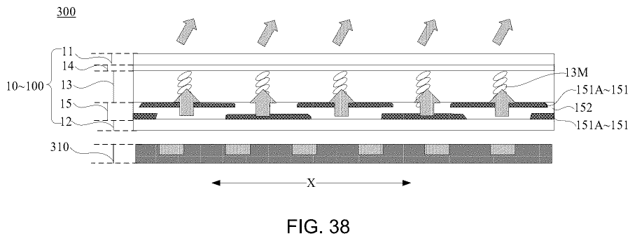

Some embodiments of the present disclosure provide a light-emitting apparatus 300. As shown in FIG. 38, the light-emitting apparatus 300 includes a light-emitting substrate 310 and the light modulation module 100 as described in any of the above embodiments. The light modulation module 100 is disposed on the light exit side of the light-emitting substrate 310 and connected to the light exit substrate 310.

For example, the light-emitting substrate 310 includes any one of an OLED light-emitting substrate, an LED light-emitting substrate, a Micro LED light-emitting substrate, and a Mini LED light-emitting substrate.

It can be understood that in the case where the light modulation module 100 is disposed on the light exit side of the light-emitting substrate 310, the light modulation module 100 may modulate the light emitted by the light-emitting substrate 310 and change the type of the light emitted by the light-emitting substrate 310. Here, the changes in light include but are not limited to the change of viewing angle, contrast or brightness.

The beneficial effects of the light-emitting apparatus 300 are the same as the beneficial effects of the light modulation module 100 provided in the foregoing embodiments of the present disclosure, and details are not described here again.

The foregoing descriptions are merely specific implementations of the present disclosure, but the protection scope of the present disclosure is not limited thereto, any changes or replacements that a person skilled in the art could conceive of within the technical scope of the present disclosure shall be included in the protection scope of the present disclosure. Therefore, the protection scope of the present disclosure should be determined by the protection scope of the claims.

1. A light modulation module, comprising: at least one light modulation unit, a light modulation unit including:
a first substrate and a second substrate that are assembled together;
a liquid crystal layer located between the first substrate and the second substrate, the liquid crystal layer including first liquid crystal molecules;
a common electrode layer located between the first substrate and the liquid crystal layer; and
a control electrode sub-module located between the second substrate and the liquid crystal layer; the control electrode sub-module including at least two control electrode layers and a dielectric layer between two adjacent control electrode layers, each control electrode layer including a plurality of control electrodes arranged at intervals in a first direction;
wherein orthographic projections of control electrodes included in two control electrode layers of the at least two control electrode layers on the second substrate are staggered in the first direction; for orthographic projections of control electrodes included in the at least two control electrode layers on the second substrate, adjacent orthographic projections are connected.

2. The light modulation module according to claim 1, wherein the control electrodes of the at least two control electrode layers include a first electrode and a second electrode; orthographic projections of the first electrode and the second electrode on the second substrate are adjacently arranged; the orthographic projection of the first electrode on the second substrate and the orthographic projection of the second electrode on the second substrate have a first overlapping portion.

3. The light modulation module according to claim 2, wherein a dimension of a control electrode of the control electrodes of the at least two control electrode layers in the first direction is a first width, and a dimension of the first overlapping portion in the first direction is a second width; a ratio of the second width to the first width is in a range of 2% to 10%, inclusive.

4. The light modulation module according to claim 1, wherein a dimension of a control electrode of the control electrodes of the at least two control electrode layers in the first direction is a first width; among a plurality of control electrodes of a control electrode layer of the at least two control electrode layers, two adjacent control electrodes have a first gap therebetween, and a dimension of the first gap in the first direction is a third width; a ratio of the first width to the third width is greater than or equal to 50% and less than or equal to 80%.

5. The light modulation module according to claim 1, wherein the light modulation unit further includes:
a light-blocking layer, the light-blocking layer includes a plurality of light-blocking patterns arranged at intervals in the first direction; an orthographic projection of a light-blocking pattern on the second substrate substantially coincides with an orthographic projection of at least one control electrode of the control electrodes of the at least two control layers on the second substrate.

6. The light modulation module according to claim 1, wherein a surface of the first substrate proximate to the liquid crystal layer has a plurality of protrusions; the common electrode layer has a shape consistent with a shape of the plurality of protrusions; or
a surface of the second substrate proximate to the liquid crystal layer has a plurality of protrusions; the control electrode sub-module has a shape consistent with a shape of the plurality of protrusions.

7. The light modulation module according to claim 6, wherein a surface of a protrusion of the plurality of protrusions proximate to the liquid crystal layer includes a plurality of sub-surfaces, a sub-surface is directly opposite to one or more control electrodes of the control electrodes of the at least two control electrode layers; the plurality of the sub-surfaces are arranged in a first shape, and the first shape includes one of a linear shape, a triangular shape and a parabola shape or a combination of more of a linear shape, a triangular shape and a parabola shape.

8. The light modulation module according to claim 6, wherein the plurality of protrusions include a plurality of rectangular protrusions, and two adjacent rectangular protrusions have a gap therebetween.

9. The light modulation module according to claim 1, a wherein the light modulation unit further includes:
a first alignment film located between the common electrode layer and the liquid crystal layer; and
a second alignment film located between the control electrode sub-module and the liquid crystal layer;
wherein a surface of the first substrate proximate to the liquid crystal layer has a plurality of protrusions, the first alignment film has a shape consistent with a shape of the plurality of protrusions; and
a surface of the second substrate proximate to the liquid crystal layer has a plurality of protrusions, the second alignment film has a shape consistent with a shape of the plurality of protrusions.

10. The light modulation module according to claim 1, wherein among the first substrate and the second substrate of the light modulation unit, one closer to a light exit side is a light exit substrate;
the light modulation unit further includes a linear polarizer disposed on a surface of the light exit substrate away from the liquid crystal layer.

11. The light modulation module according to claim 1, wherein a thickness of the dielectric layer is less than or equal to 2500 Å.

12. The light modulation module according to claim 1, wherein a difference between an extraordinary refractive index of the first liquid crystal molecules and an ordinary refractive index of the first liquid crystal molecules is greater than or equal to 0.2.

13. The light modulation module according to claim 1, wherein there exist a plurality of light modulation units, and the plurality of light modulation units are stacked in a thickness direction of the liquid crystal layer; wherein
arrangement directions of control electrodes of two adjacent light modulation units are parallel or intersect with each other.

14. The light modulation module according to claim 1, wherein there exist two light modulation units, the two light modulation units are stacked in a thickness direction of the liquid crystal layer, and arrangement directions of control electrodes of the two light modulation units are particular to each other.

15. A driving method of a light modulation module, wherein the light modulation module is the light modulation module according to claim 1;
the driving method of the light modulation module comprises:
inputting control voltages to a plurality of control electrodes, and inputting a common voltage to the common electrode layer to drive the first liquid crystal molecules to rotate from an initial state to a first stable state, so that refractive index distribution of the light modulation unit is periodically arranged in the first direction entirely or locally.

16-24. (canceled)

25. The driving method of the light modulation module according to claim 15, wherein there exist two control electrode layers, and control electrodes of a control electrode layer farther away from the liquid crystal layer includes a third electrode, and a control electrode layer closer to the liquid crystal layer includes two fourth electrodes adjacent to the third electrode;
in a case where the first liquid crystal molecules rotate to the first stable state, a control voltage applied to the third electrode is a first voltage, voltages applied to the two fourth electrodes are a second voltage and a third voltage respectively, and the second voltage is greater than the third voltage;
wherein the first voltage is greater than the third voltage, and less than the second voltage; or
the first voltage is equal to the second voltage; or
the first voltage is equal to the third voltage.

26. A display apparatus, comprising the light modulation module according to claim 1 and a display substrate; wherein the light modulation module is connected to the display substrate.

27. The display apparatus according to claim 26, wherein the display substrate is any one of an OLED display substrate, an LED display substrate, a micro LED display substrate and a mini LED display substrate; and the light modulation module is disposed on a light exit side of the display substrate.

28. The display apparatus according to claim 26, wherein the display substrate is an LCD display substrate, the display apparatus further comprises a backlight module;
wherein the backlight module is disposed on a side of the display substrate away from the backlight module; or
the light modulation module is disposed between the display substrate and the backlight module.

29. (canceled)

30. A light-emitting apparatus, comprising: the light modulation module according to claim 1 and a light-emitting substrate; wherein the light modulation module is disposed on a light exit side of the light-emitting substrate and connected to the light-emitting substrate.
